(19) United States
(12) Patent Application Publication
(10) Pub. No.: US 2026/0075529 A1
(43) Pub. Date: Mar. 12, 2026

(54) Multi-Access Point Channel Access Control

(71) Applicant: Ofinno, LLC, Reston, VA (US)

(72) Inventors: Jeongki Kim, Fairfax, VA (US); Leonardo Alisasis Lanante, Reston, VA (US); Esmael Hejazi Dinan, McLean, VA (US)

(73) Assignee: Ofinno, LLC, Reston, VA (US)

(21) Appl. No.: 19/384,140

(22) Filed: Nov. 10, 2025

Related U.S. Application Data
(63) Continuation of application No. PCT/US2024/027925, filed on May 6, 2024.
(60) Provisional application No. 63/465,581, filed on May 11, 2023.

(51) Int. Cl. H04W 52/02; H04W 28/086

(52) U.S. Cl. CPC H04W 52/0235; H04W 28/0861

(57) ABSTRACT

A station (STA) receives a first beacon frame transmitted by a first access point (AP) and announcing a restricted target wake time (R-TWT) service period (SP) of a second AP. The STA transmits, to the first AP after receiving the first beacon frame, a second frame initiating a first transmit opportunity (TXOP). Based on the STA supporting R-TWT operation and being a member of a same basic service set (BSS) as the first AP, the STA ends the first TXOP before a start time of the R-TWT SP of the second AP.

### CROSS-REFERENCE TO RELATED APPLICATIONS

This application is a continuation of International Application No. PCT/US2024/027925, filed May 6, 2024, which claims the benefit of U.S. Provisional Application No. 63/465,581, filed May 11, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of target wake time (TWT) operation.

FIG. 4 illustrates an example of TWT operation in an environment including an AP multi-link device (AP MLD) and a station multi-link device (STA MLD).

FIG. 5 illustrates an example TWT element which may be used to support individual TWT operation.

FIG. 6 illustrates an example TWT element which may be used to support restricted TWT (r-TWT) operation.

FIG. 7 illustrates an example of individual TWT operation.

FIG. 8 illustrates an example of broadcast TWT operation.

FIG. 9 illustrates an example of TWT protection in individual TWT operation.

FIG. 10 illustrates an example of r-TWT operation.

FIG. 11 is an example that illustrates inter-basic service set (BSS) interference due to overlap between a transmission opportunity (TXOP) of a BSS with r-TWT service periods (SPs) of overlapping BSSs.

FIG. 12 is an example that illustrates the use of coordinated medium access (CMA) to reduce the inter-BSS interference illustrated in FIG. 11.

FIG. 13 is an example that illustrates a proposed channel access procedure according to an embodiment of the present disclosure.

FIG. 14 is an example that illustrates another proposed channel access procedure according to an embodiment of the present disclosure.

FIG. 15 is an example that illustrates another proposed channel access procedure according to an embodiment of the present disclosure.

FIG. 16 is an example that illustrates another proposed channel access procedure according to an embodiment of the present disclosure.

FIG. 17 is an example that illustrates another proposed procedure according to an embodiment of the present disclosure.

FIG. 18 illustrates an example process according to an embodiment.

FIG. 19 illustrates another example process according to an embodiment.

FIG. 20 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAS, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

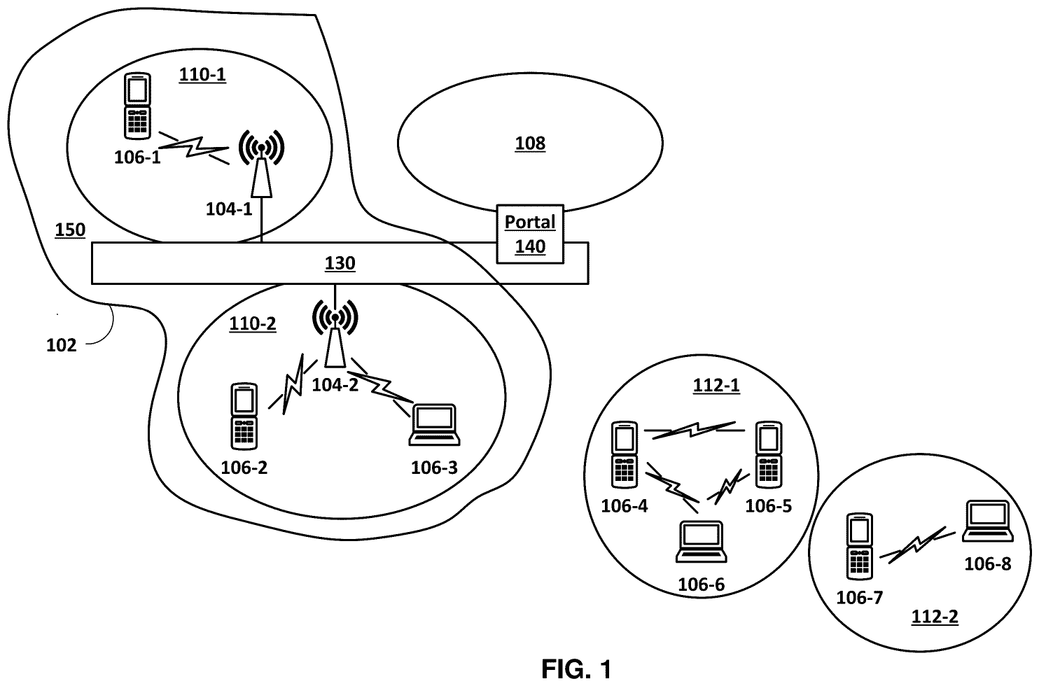

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

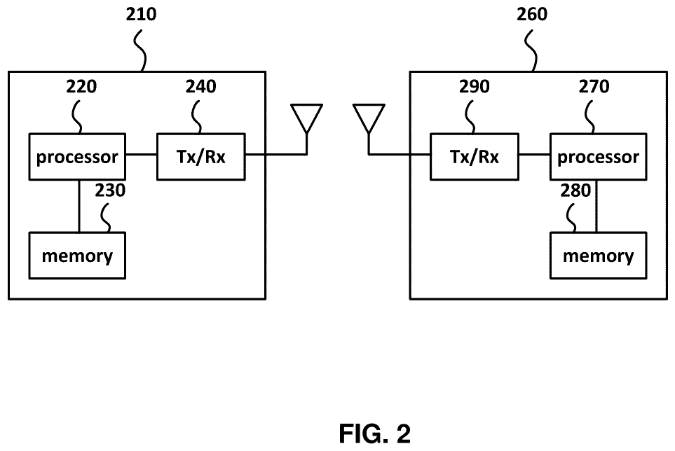

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

In an individual TWT, a STA that requests a TWT agreement is called a TWT requesting STA. The TWT requesting STA may be a non-AP STA for example. The STA that responds to the request is called a TWT responding STA. The TWT responding STA may be an AP for example. The TWT requesting STA is assigned specific times to wake up and exchange frames with the TWT responding STA. The TWT requesting STA may communicate wake scheduling information to the TWT responding STA. The TWT responding STA may transmit TWT values to the TWT requesting STA when a TWT agreement is established between them.

When explicit TWT is employed, the TWT requesting STA may wake up and perform a frame exchange. The TWT requesting STA may receive a next TWT information in a response from the TWT responding STA. When implicit TWT is used, the TWT requesting STA may calculate a next TWT by adding a fixed value to the current TWT value.

The TWT values for implicit TWT may be periodic. The TWT requesting STA operating with an implicit TWT agreement may determine a next TWT service period (TWT SP) start time by adding a value of a TWT wake interval associated with the TWT agreement to the value of the start time of the current TWT SP. The TWT responding STA may include the start time for a series of TWT SPs corresponding to a single TWT flow identifier of an implicit TWT agreement in a target wake time field of a TWT element. The TWT element may contain a value of ‘accept TWT’ in a TWT setup command field. The start time of the TWT SP series may indicate the start time of a first TWT SP in the series. Start times of subsequent TWT SPs may be determined by adding the value of the TWT wake interval to the start time of the current TWT SP. In an example, the TWT requesting STA, awake for an implicit TWT SP, may enter a doze state after the TWT SP has elapsed or after receiving an end of service period (EOSP) field equal to 1 from the TWT responding STA, whichever occurs first.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for an SP duration. The TWT SP may repeat every SP interval.

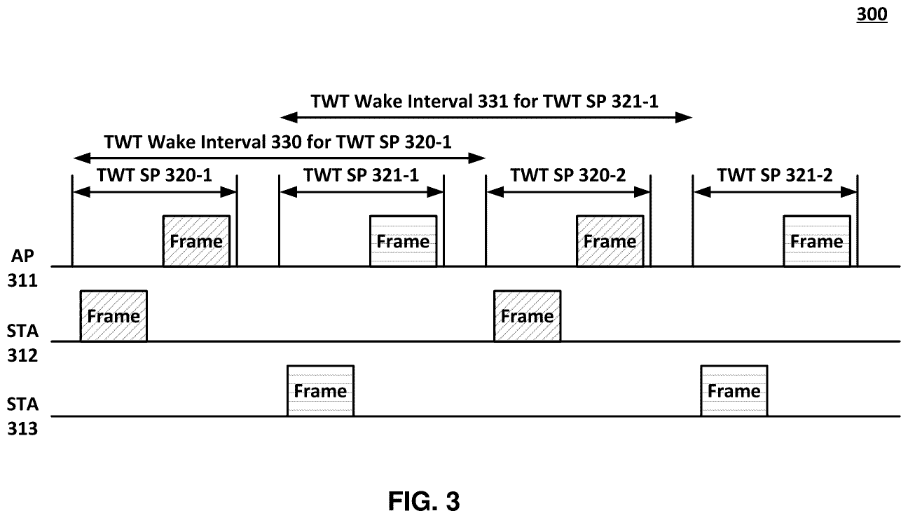

FIG. 3 illustrates an example 300 of TWT operation. As shown in FIG. 3, example 300 includes an AP 311, a STA 312, and a STA 313. AP 311 and STA 312 may establish a TWT SP 320. AP 311 and STA 313 may establish a TWT SP 321. TWT SP 320 and TWT SP 321 may repeat as shown in FIG. 3, such that TWT SP 320 may include a first TWT SP 320-1 and a second TWT SP 320-2, and such that TWT SP 321 may include a first TWT SP 321-1 and a second TWT SP 321-2.

AP 311 and STA 312 may exchange frames during first TWT SP 320-1. STA 312 may enter a doze state at the end of TWT SP 320-1 and may remain in the doze state until the start of second TWT SP 320-2. The start of second TWT SP 320-2 may be indicated by a TWT wake interval 330 associated with TWT SP 320. AP 311 and STA 312 may again exchange frames during second TWT SP 320-2.

Similarly, AP 311 and STA 313 may exchange frames during first TWT SP 321-1. STA 313 may enter a doze state at the end of first TWT SP 321-1 and may remain in the doze state until the start of second TWT SP 321-2. The start of second TWT SP 321-2 may be indicated by a TWT wake interval 331 associated with TWT SP 321. AP 311 and STA 313 may again exchange frames during second TWT SP 31-2.

In an awake state, a STA may be fully powered. The STA may transmit and/or receive a frame to/from an AP or another STA. In a doze state, a STA may not transmit and may not receive a frame to/from an AP or another STA.

An MLD is an entity capable of managing communication over multiple links. The MLD may be a logical entity and may have more than one affiliated station (STA). The MLD may have a single MAC service access point (MAC-SAP) to the LLC layer, which includes a MAC data service. An MLD may be an access point MLD (AP MLD) when a STA affiliated with the MLD is an AP STA (or an AP). An MLD may be a non-access point MLD (non-AP MLD) or STA MLD when a STA affiliated with the MLD is a non-AP STA (or a STA).

During negotiation of TWT agreements, a TWT requesting STA affiliated with a STA MLD and a TWT responding STA affiliated with an AP MLD may communicate multiple TWT elements. The TWT elements may comprise link ID bitmap subfields indicating different link(s) in a TWT setup frame. The TWT parameters provided by a TWT element may be applied to the respective link that is indicated in the TWT element.

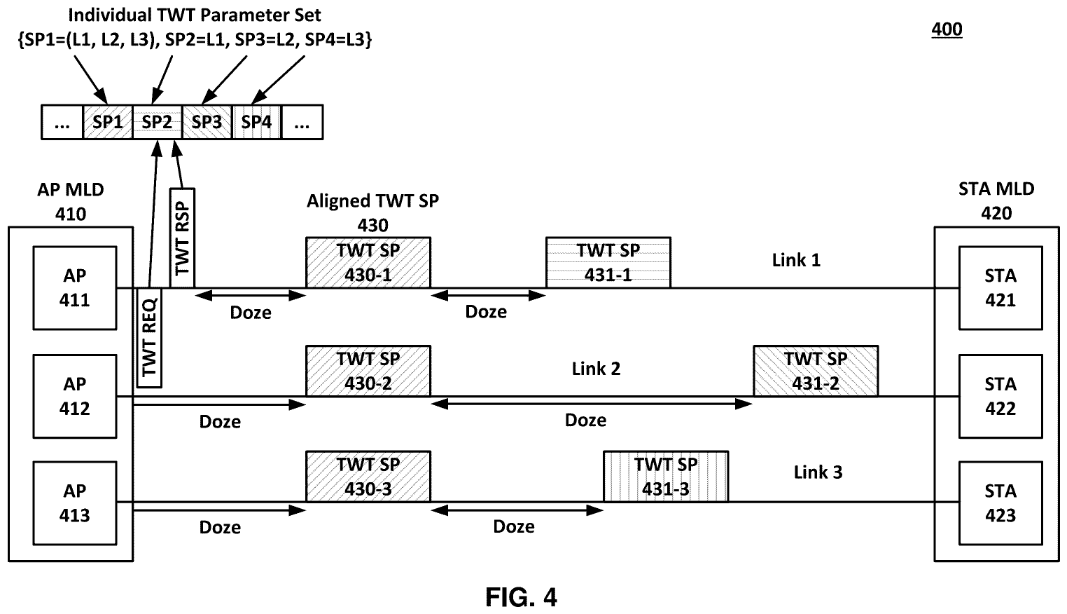

FIG. 4 illustrates an example 400 of TWT operation in a multi-link environment including an AP multi-link device (AP MLD) 410 and a STA multi-link device (STA MLD) 420. As shown in FIG. 4, AP MLD 410 may have three affiliated APs, AP 411, AP2 412, and AP3 413. In an example, AP 411, AP2 412, and AP3 413 may operate respectively on the 2.4 GHz band, the 5 GHz band, and the 6 GHz band. STA MLD 420 may have three affiliated STAs, STA 421, STA 422, and STA 423. In an example, STA 421, STA 422, and STA 423 may operate respectively on the 2.4 GHz band, the 5 GHz band, and the 6 GHz band. In an example, AP 411, AP2 412, and AP3 413 may be communicatively coupled via a first link (link 1), a second link (link 2), and a third link (link 3) respectively with STA 421, STA 422, and STA 423, respectively.

In an example, STA 421 may transmit a TWT request to AP 411. The TWT request may include three TWT elements. Each TWT element may indicate a respective link of links 1-3 and may request the setup of a TWT agreement for the indicated link. The three TWT elements may have different TWT parameters, such as target wake time (TWT). In response to the TWT request, AP 411 may transmit a TWT response to STA 421. The TWT response may include three TWT elements. Each TWT element may indicate a respective link of links 1-3 and may include a value of ‘accept TWT’ in a TWT setup command field.

Successful TWT agreement setup on links 1-3 establishes three TWT SPs with same or different TWT parameters on links 1-3 respectively. The target wake time field of the TWT element indicating a given link indicates the start time of the TWP SP for that link. The starting time may be indicated in reference to a time synchronization function (TSF) time of the link.

In example 400, initial TWT SPs 430-1, 430-2, and 430-3 of links 1-3 respectively may be aligned. TWT wake intervals associated with the TWT agreements of links 1-3 respectively may be set differently. As such, second TWT SPs 431-1, 431-2, and 431-3 of links 1-3 respectively may not be aligned. STA 421, STA 422, and STA 423 may enter a doze state between the end of initial TWT SPs 430-1, 430-2, and 430-3, respectively, and the start of second TWT SPs 431-1, 431-2, 431-3, respectively.

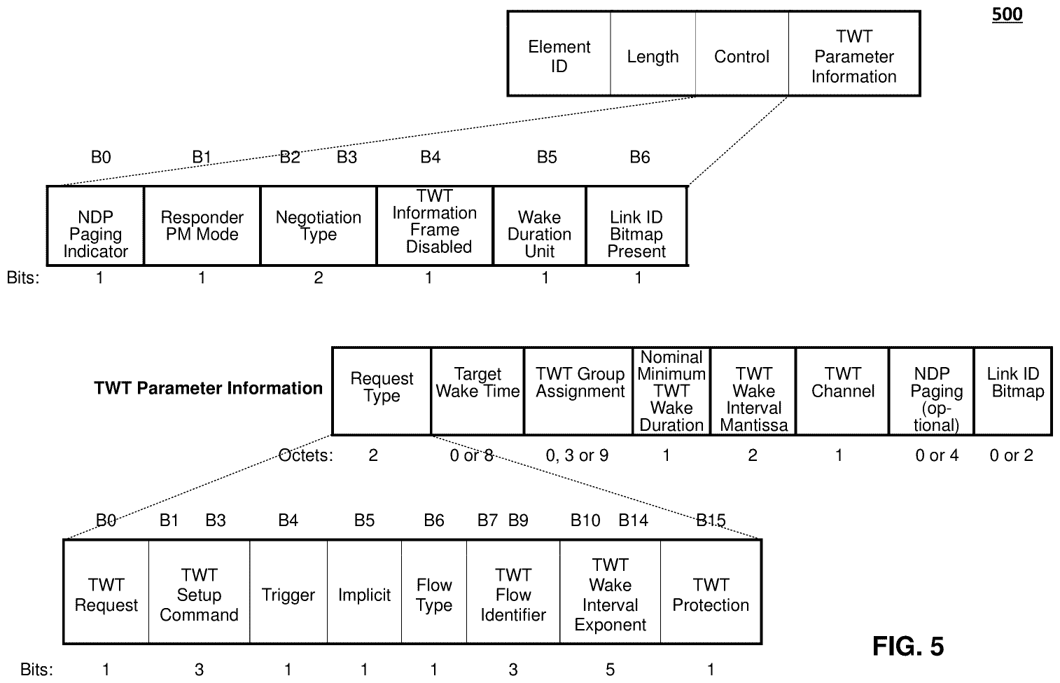

FIG. 5 illustrates an example target wake time (TWT) element 500 which may be used to support individual TWT operation.

In an example, an AP and a STA may use TWT element 500 to negotiate a TWT agreement. The AP and/or the STA may transmit TWT element 500 in an individually addressed management frame. The management frame may be of the type action, action no ack, (re)association request/response, and probe request response, for example.

The TWT schedule and parameters may be provided during a TWT setup phase. Renegotiation/changes of TWT schedules may be signaled via individually addressed frames that contain the updated TWT schedule/parameters. The frames may be management frames as described above or control or data frames that carry a field containing the updated TWT schedule/parameters.

Referring to FIG. 5, TWT element 500 includes an element ID field, a length field, a control field, and a TWT parameter information field.

The element ID field (e.g., 1 octet in length) may indicate that information element 500 is a TWT element. The length field (e.g., 1 octet) may indicate the length of TWT element 500 starting from the control field until an end of TWT element 500. The end of TWT element 500 may be the end of a TWT Channel field or the end of a Link ID bitmap field of the TWT parameter information field.

The TWT parameter information field may include a request type field (e.g., 2 octets), a target wake time field (e.g., 8 octets or less), a TWT group assignment field (e.g., 9, 3, 2, or 0 octets), a nominal minimal TWT wake duration field (e.g., 1 octet), a TWT wake interval mantissa (e.g., 2 octets), a TWT channel field (e.g., 1 octet), an optional NDP paging field (e.g., 0 or 4 octets), and/or a Link ID bitmaps field (e.g., 0 or 2 Octets).

The request type field may indicate a type of TWT request. The request type field may include a TWT request field (e.g., 1 bit), a TWT setup command field (e.g., 3 bits), a trigger field (e.g., 1 bit), an implicit field (e.g., 1 bit), a flow type (e.g., 1 bit), a TWT flow identifier (e.g., 3 bits), a TWT wake interval exponent (e.g., 5 bits), and/or a TWT protection field (e.g., 1 bit).

The TWT request field may indicate whether the TWT element 500 represents a request. If TWT request field has a value of 1, then the TWT element 500 may represent a request to initiate TWT scheduling/setup.

The TWT setup command field may indicate a type of TWT command. In a TWT request, the type of TWT command indicated may be: a request TWT (the TWT responding STA specifies the TWT value; e.g., field set to 0), a suggest TWT (the TWT requesting STA suggests a TWT value; e.g., field set to 1), and a demand TWT (the TWT requesting STA demands a TWT value; e.g., field set to 2).

In a TWT response, the type of TWT command indicated may be: TWT grouping (the TWT responding STA suggests TWT group parameters that are different than the suggested or demanded TWT parameters of the TWT requesting STA; e.g., field set to 3), accept TWT (the TWT responding STA accepts the TWT request with the TWT parameters indicated by the TWT requesting STA; e.g. field set to 4), alternate TWT (the TWT responding STA suggests TWT parameters that are different than the parameters suggested or demanded by the TWT requesting STA; e.g., field set to 5), dictate TWT (the TWT responding STA demands TWT parameters that are different than the parameters suggested or demanded by the TWT requesting STA; e.g., field set to 6), or reject TWT (the TWT responding STA rejects the TWT setup; e.g. field set to 7).

In a TWT response, the TWT command may also indicate an unsolicited response or a broadcast TWT. An unsolicited TWT response is an individually addressed frame that is intended for a specific STA. An unsolicited TWT response may be followed by an ACK frame from the STA receiving the unsolicited TWT response. A broadcast TWT may be intended for multiple STAs and may be carried in a broadcast frame such as, for example, a beacon frame. A broadcast TWT may not be acknowledged by receiving STAs.

An unsolicited TWT response may be used a TWT responding STA to demand that a recipient follow a TWT schedule contained in the TWT element. In an embodiment, an unsolicited TWT response may have the TWT request field set to 0 and a value of ‘dictate TWT’ in the TWT setup command field. A broadcast TWT response may be used by a TWT responding STA to schedule a TWT for any STA that receives and decodes the TWT element.

In certain embodiments, a TWT element, such as TWT element 500, may contain TWT parameter sets for multiple TWT negotiations or indications as described herein. As such, the TWT element may include multiple instances of the Control and the TWT parameter information fields. The TWT flow identifier of the request type field indicates the TWT negotiation which parameters are carried by the TWT parameter information field.

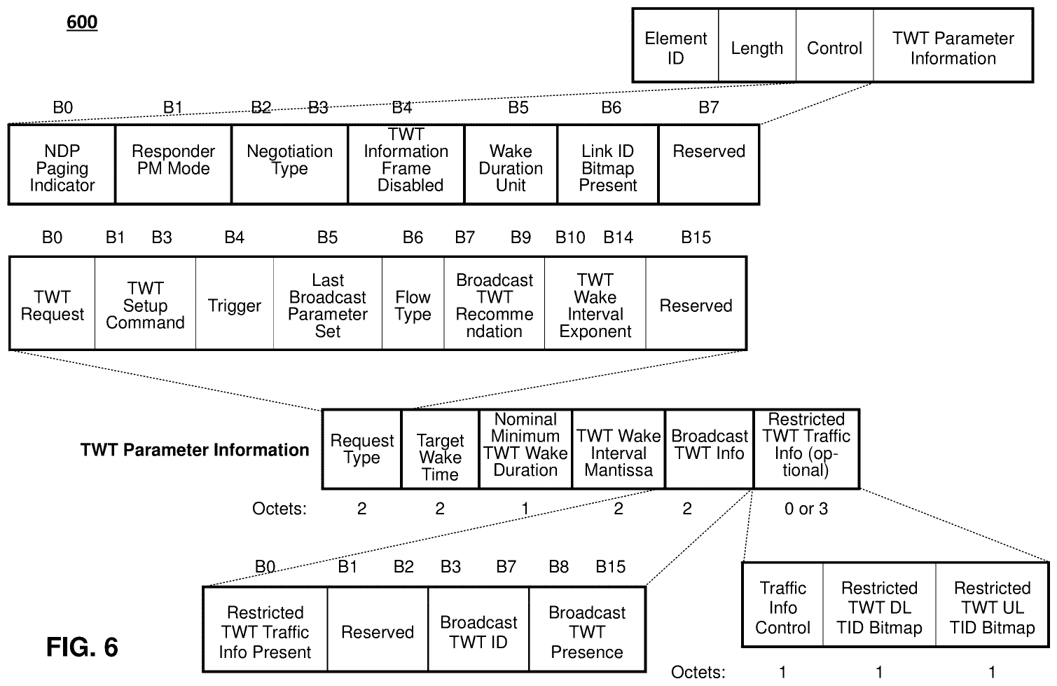

FIG. 6 illustrates an example target wake time (TWT) element 600 which may be used to support restricted TWT (r-TWT) operation. For r-TWT, TWT element 600 may be transmitted in a broadcast management frame, which can be a beacon frame, a TIM broadcast frame, a probe response frame, etc. In this embodiment, TWT element 600 provides non-negotiated TWT schedules (e.g., broadcast TWT schedules).

As shown, TWT element 600 includes an element ID field, a length field, a control field, and a TWT parameter information field.

The element ID field (e.g., 1 octet in length) may indicate that information element 600 is a TWT element. The length field (e.g., 1 octet) may indicate the length of TWT element 600 starting from the control field until an end of TWT element 600. The end of TWT element 600 may be the end of a broadcast TWT info field or the end of a r-TWT traffic info field of the TWT parameter information field.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional r-TWT traffic info field (e.g., 0 or 3 octets).

The request type field may include, among other fields, a TWT request field, a flow type field, and a TWT wake interval exponent field.

The TWT request field indicates whether TWT element 600 is a request. If the TWT request field has a value of 0, then TWT element 600 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa)×2^{(TWT Wake Interval Exponent)}. The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to 1 may indicate an unannounced TWT. In an unannounced TWT, the TWT responding STA may transmit a frame to the TWT requesting STA within a TWT SP before it has received a frame from the TWT requesting STA.

Within a TWT element that includes a TWT setup command value of ‘request TWT’, ‘suggest TWT’, or ‘demand TWT’, a broadcast TWT ID may indicate a specific broadcast TWT in which the TWT requesting STA is requesting to participate. Within a TWT element that includes a TWT setup command value of ‘accept TWT’, ‘alternate TWT’, ‘dictate TWT’, or ‘reject TWT’, a broadcast TWT ID may indicate a specific broadcast TWT for which the TWT responding STA is providing TWT parameters. The value 0 in the broadcast TWT ID subfield may indicate the broadcast TWT whose membership corresponds to all STAs that are members of the BSS corresponding to the BSSID of the management frame carrying the TWT element and that is permitted to contain trigger frames with random access resource units for unassociated STAs. The Broadcast TWT ID subfield in a r-TWT Parameter set field is always set to a nonzero value.

A broadcast TWT element 600 that contains a r-TWT parameter set is also referred to as a r-TWT element. A r-TWT traffic info present subfield of the broadcast TWT info field may be set to 1 to indicate the presence of the r-TWT traffic info field in TWT element 600. The r-TWT traffic info field is present in a r-TWT parameter set field when the r-TWT traffic info present subfield is set to 1.

The r-TWT traffic info field may include a traffic info control field, a r-TWT DL TID bitmap field, and a r-TWT UL TID bitmap field.

The traffic info control field may include a DL TID bitmap valid subfield and an UL TID bitmap valid subfield. The DL TID bitmap valid subfield indicates if the r-TWT DL TID bitmap field has valid information. When the value of the DL TID bitmap valid subfield is set to 0, it may indicate that DL traffic of TIDs is identified as latency sensitive traffic, and the r-TWT DL TID bitmap field is reserved. The UL TID bitmap valid subfield may indicate if the r-TWT UL TID bitmap field has valid information. When the value of the UL TID bitmap valid subfield is set to 0, it may indicate that UL traffic of TIDs is identified as latency sensitive traffic, and the r-TWT UL TID bitmap field is reserved.

The r-TWT DL TID bitmap subfield and the r-TWT UL TID bitmap subfield may specify which TID(s) are identified by the TWT scheduling AP or the TWT scheduled STA as latency sensitive traffic streams in a downlink and an uplink direction, respectively. A value of 1 at bit position k in the bitmap indicates that TID k is classified as a latency sensitive traffic stream. A value of 0 at bit position k in the bitmap indicates that TID k is not classified as a latency sensitive traffic stream.

An individual target wake time (TWT) may be a specific time or set of times negotiated between two individual stations (e.g., a STA and another STA, or a STA and an AP, etc.) at which the stations may be awake to exchange frames during a service period (SP) of the TWT.

In trigger-enabled TWT, an AP may transmit a trigger frame for scheduling uplink multi-user transmissions from one or more STAs using uplink OFDMA (orthogonal frequency division multiple access) and/or uplink MU-MIMO (multi-user multiple input multiple output) during a trigger-enabled TWT SP. A TWT STA that receives the trigger frame from the AP may transmit a frame to the AP through a resource indicated in the trigger frame during the trigger-enabled TWT SP.

In non-trigger-enabled TWT, an AP may not be required to transmit a trigger frame to schedule uplink multi-user transmissions from one or more STAs during a non-trigger-enabled TWT SP.

In announced TWT, a STA may transmit a frame (e.g., a PS-Poll frame or a QoS null frame) to the AP to retrieve a downlink buffered data from the AP during a TWT SP. In unannounced TWT, an AP may transmit downlink data to a TWT STA without receiving a frame (e.g., a PS-Poll frame, or a QoS null frame) from the TWT STA during a TWT SP.

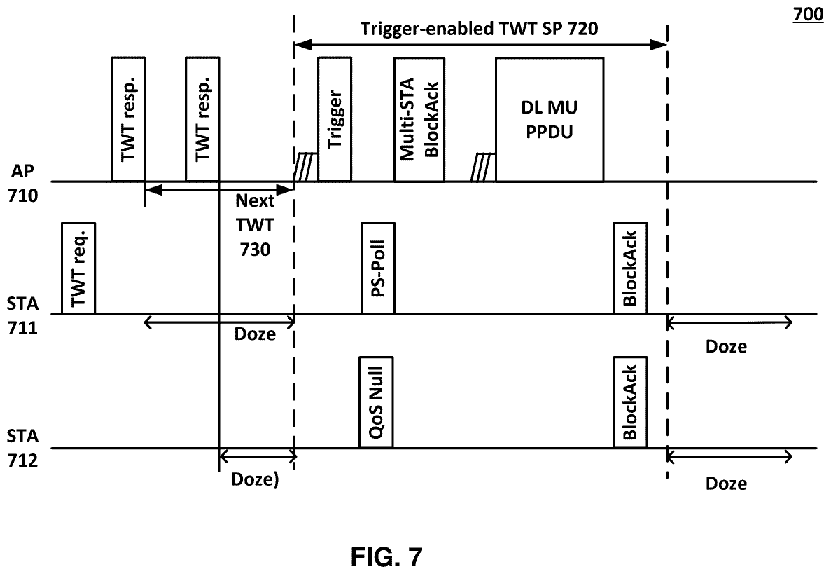

FIG. 7 illustrates an example 700 of individual TWT operation. As shown in FIG. 7, example 700 includes an AP 710, a STA 711, and a STA 712. In an example, AP 710 may be a TWT responding STA and STA 711 and STA 712 may be TWT requesting STAs.

In an example, STA 711 may transmit a TWT request to AP 710 to setup a first trigger-enabled TWT agreement. STA 711 may set a trigger field of the TWT request to 1 to indicate that it is requesting a trigger-enabled TWT. AP 710 may accept the first TWT agreement with STA 711. AP 710 may confirm the acceptance in a TWT response sent to STA 711. The TWT response may indicate a next TWT 730, which indicates the time until a next TWT SP 720 according to the first TWT agreement.

In an example, AP 710 may transmit an unsolicited TWT response to STA 712 to set up a second trigger-enabled TWT agreement with STA 712 without receiving a TWT request from STA 712. The first and second TWT agreements may be set up as announced TWTs.

After the setup of the TWT agreements, STA 711 and STA 712 may enter a doze state until the start of TWT SP 720. During trigger-enabled TWT SP 720, AP 710 may transmit a trigger frame. STA 711 and STA 12 may respond to the trigger frame by indicating that they are in awake state. In an example, STA 711 may transmit a power save poll (PS-Poll) frame. The PS-Poll frame may comprise a BSSID (receiver address: RA) field set to an address of AP 710 and a transmitter address (TA) field set to an address of STA 711. In an example, STA 712 may transmit a QoS null frame in response to the trigger frame. The QoS null frame may comprise a MAC header (e.g., a frame control field, a duration field, address fields, a sequence control field, QoS control field) without a frame body.

In response to the PS-Poll frame and the QoS null frame, AP 710 may transmit a multi-STA Block Ack (M-BA) frame. The M-BA frame may include acknowledgement information associated with the PS-Poll frame and the QoS null frame received from STAs 711 and 712 respectively. Subsequently, STA 711 and STA 712 may receive downlink bufferable units (DL BUs) from AP 710. The DL BUs may include a medium access control (MAC) service data unit (MSDU), an aggregate MAC service data unit (A-MSDU), and/or a bufferable MAC management protocol data unit (MMPDU). STA 711 and STA 712 may transmit Block Ack (BA) frames in response to the DL BUs. At the end of the TWT SP 720, STA 711 and STA 712 may return to a doze state.

A STA may execute individual TWT setup exchanges. The STA may not transmit frames to an AP outside of negotiated TWT SPs. The STA may not transmit frames that are not contained within high efficiency trigger-based physical protocol data units (HE TB PPDUs) to the AP within trigger-enabled TWT SPs. A HE TB PPDU may be transmitted by a STA based on receiving a trigger frame triggering uplink multi-user transmissions.

The AP of a trigger-enabled TWT agreement may schedule for transmission a trigger frame for a STA within the trigger-enabled TWT SP. The STA may transmit an HE TB PPDU as a response to the trigger frame sent during the trigger-enabled TWT SP. A STA that is in power save (PS) mode may include a PS-Poll frame or a QoS null frame in the HE TB PPDU if the TWT is an announced TWT, to indicate to the AP that the STA is currently in the awake state. The AP that receives the PS-Poll frame or the QoS Null frame or any other indication from an STA in PS mode, may deliver to the STA as many buffered BUs as are available at the AP during the TWT SP.

A broadcast target wake time (TWT) may be a specific time or set of times broadcast by an AP to one or more STAs at which the STAs may be awake to exchange frames with the AP during a SP of the TWT.

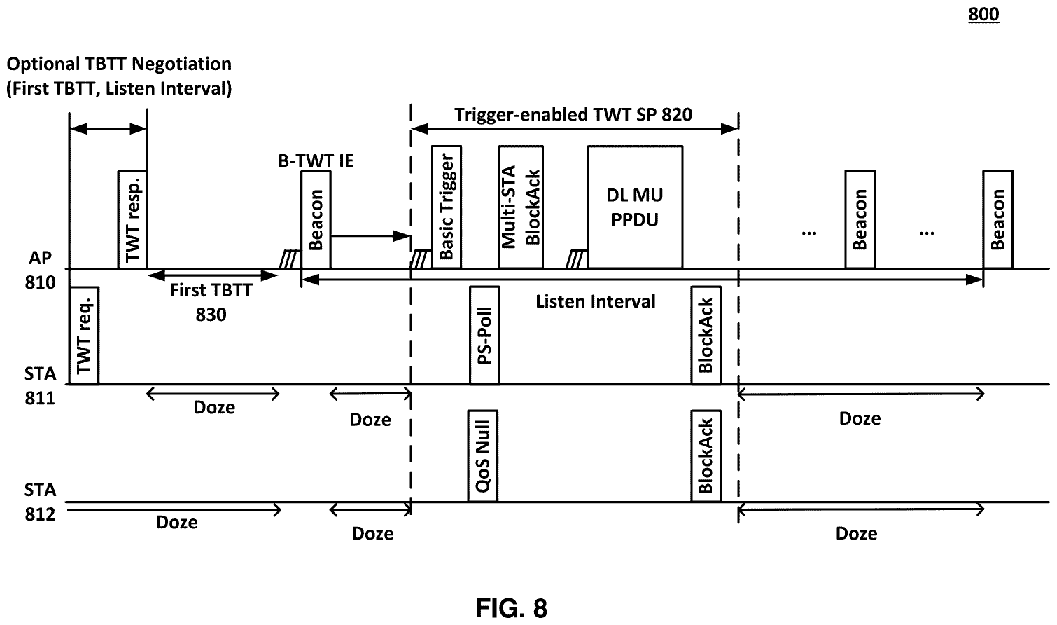

FIG. 8 illustrates an example 800 of broadcast TWT operation. As shown in FIG. 8, example 800 includes an AP 810, a STA 811, and a STA 812. In an example 800, AP 810 may be a TWT scheduling AP and STA 811 and STA 812 may be TWT scheduled STAs.

In an example, AP 810 may include a broadcast TWT element in a beacon frame that indicates a trigger-enabled TWT SP 820. During the trigger-enabled TWT SP 820, AP 810 may transmit trigger frames or DL BUs to STA 811 and STA 812. Beacon frames may be sent by AP 810 periodically at target beacon transmission times (TBTTs). The number of time units (TUs) between consecutive TBTTs is called the beacon interval. A TU is equal to 1024 microseconds.

In an example, STA 811 and STA 812 may enter a doze state until the first target beacon transmission time (TBTT). STA 811 and STA 812 may wake up to receive the beacon frame at the first TBTT to determine the broadcast TWT. Upon reception of a broadcast TWT element in a beacon frame, STA 811 and STA 812 may re-enter the doze state until the start of trigger-enabled TWT SP 820.

During trigger-enabled TWT SP 820, AP 810 may transmit a basic trigger frame to STA 811 and STA 812. STA 811 may indicate that it is awake by transmitting a PS-Poll, and STA 812 may indicate that it is awake by transmitting a QoS null frame in response to the basic trigger frame. Subsequently, STA 811 and STA 812 may receive DL BUs from AP 810. STA 811 and STA 812 may return to the doze state outside of the TWT SP 720.

In an example, a STA that intends to operate in power save mode may negotiate a wake TBTT and a wake interval with the AP. For example, as shown in FIG. 8, STA 811 may transmit a TWT request to AP 810 that identifies a wake TBTT of the first beacon frame and a wake interval between subsequent beacon frames. AP 810 may respond with a TWT response to the TWT request confirming the wake TBTT and wake interval. After successfully completing the negotiation, STA 811 may enter a doze state until a first negotiated wake TBTT 830. STA 811 may be in an awake state to listen to the beacon frame transmitted at first negotiated wake TBTT 830. If STA 811 receives a beacon frame from AP 810 at or after TBTT 830, STA 811 may return to the doze state until the next wake TBTT unless a traffic indication map (TIM) element in a beacon frame includes a positive indication for STA 811. The STA 811 may return to the doze state after a nominal minimum TBTT wake duration time has elapsed from the TBTT start time.

A Network Allocation Vector (NAV) is an indicator, maintained by a station (STA), of time periods when transmission onto the wireless medium (WM) may not be initiated by the STA regardless of whether the clear channel assessment (CCA) function of the STA senses that the WM is busy. A STA that receives at least one valid frame in a PSDU may update its NAV with the information from any valid duration field in the PSDU. The STA may update the NAV when a value of the received duration field is greater than the current NAV value of the STA.

A TWT protection is a mechanism employed to protect a TWT session from external STA transmissions. During a TWT SP configured to protect the TWT session, a STA that initiates a transmission opportunity (TXOP) to transmit a frame may transmit a request to send (RTS) frame or a clear to send (CTS) frame to protect the TWT session by setting the NAV of other STAs based on receiving of the RTS frame and/or the CTS frame. The RTS frame may comprise a frame control field, a duration field, a receiver address (RA) field, a transmitter address (TA) field, and a frame check sequence (FCS) field. The CTS frame may comprise a frame control field, a duration field, a receiver address (RA) field, and a frame check sequence (FCS) field.

The TWT protection field in a TWT element may indicate whether a TWT is protected or unprotected. A TWT requesting STA may set the TWT protection field to 1 to request the TWT responding STA to provide protection for the set of TWT SPs. A TWT protection field equal to 1 may indicate to use a NAV protection mechanism to protect access to the medium during the corresponding TWT SPs.

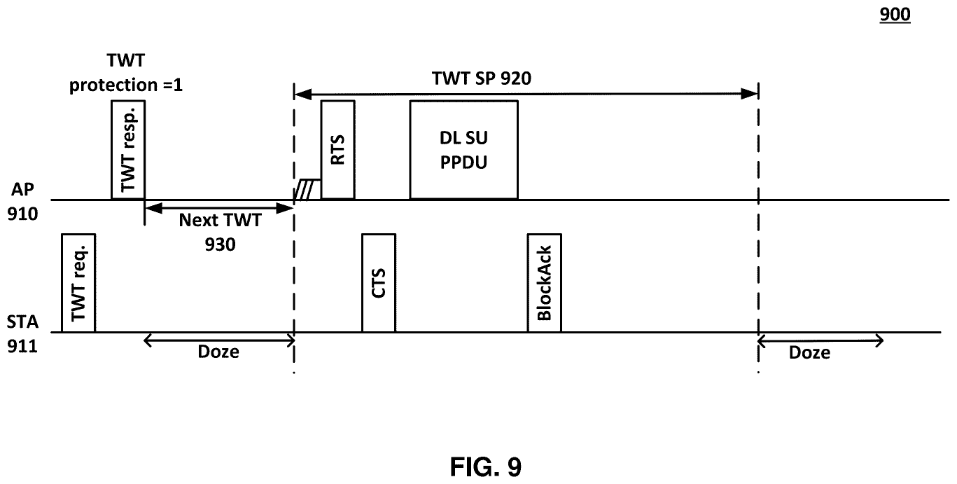

FIG. 9 illustrates an example 900 of TWT protection in individual TWT operation. As shown in FIG. 9, example 900 includes an AP 910 and a STA 911.

In an example, AP 910 may set the TWT protection field to 1 in a TWT response frame to protect the TWT SPs using a NAV protection mechanism. Upon reception of the TWT response frame, STA 911 may enter a doze state until the next TWT 930. AP 910 that has set the TWT protection field to 1 may transmit a NAV setting frame at the start of the TWT SP 920. For example, the NAV setting frame may be an RTS frame or a CTS frame.

A STA that receives the NV setting frame and that is not scheduled to access the medium during the TWT SP 920 may set their NAV according to the NAV setting frame. The STA may not access the medium for the specified amount of time in the NAV setting frame.

STA 911 may be scheduled to access the medium during the TWT SP 920. STA 911 may respond to the RTS frame with a CTS frame. Upon receiving the CTS frame, AP 910 may transmit a downlink frame to STA 911. STA 911 may respond to the downlink frame with a BA frame. When the TWT SP 920 ends, STA 911 may return to the doze state.

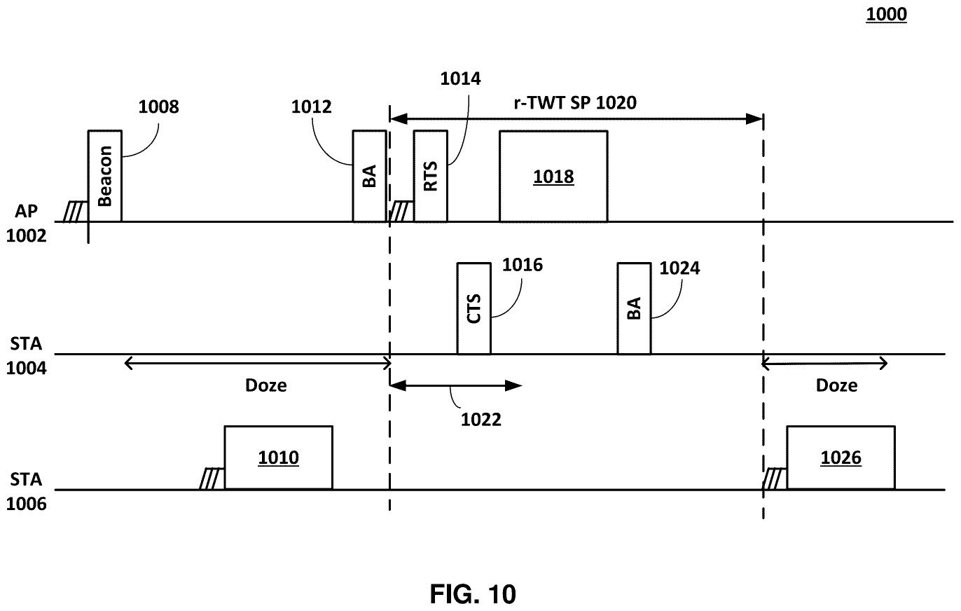

FIG. 10 illustrates an example 1000 of r-TWT operation. As shown in FIG. 10, example 1000 includes an AP 1002, a STA 1004, and a STA 1006.

In an example, an r-TWT agreement (hereinafter “r-TWT”) may be setup between AP 1002 and STA 1004. The r-TWT may not include STA 1006. For example, STA 1006 may be a legacy STA or an EHT STA not scheduled by AP 1002 as part of the r-TWT agreement.

In an example, AP 1002 may transmit a beacon frame 1008 including a TWT element that indicates an r-TWT SP 1020 of the setup r-TWT and TIDs allowed to be transmitted during the setup r-TWT. Beacon frame 1008 may also include a quiet element indicating a quiet interval 1022.

Upon receiving beacon frame 1008, STA 1004 may enter a doze state and may remain in the doze state until the start of r-TWT SP 1020. STA 1006, which is not scheduled by AP 1002 for r-TWT SP 1020, may transmit a data frame 1010 after receiving beacon frame 1008. However, STA 1006 must end its transmission before the start of r-TWT SP 1020. AP 1002 may transmit a BA frame 1012 in response to data frame 1010.

During r-TWT SP 1020, AP 1002 and STA 1004 may exchange an RTS frame 1014 and a CTS frame 1016. Subsequently, AP 1002 may send a data frame 1018 to STA 1004. Data frame 1018 includes traffic having a TID from among the TIDs indicated as permitted to transmit during r-TWT SP 1020 in beacon frame 1008. STA 1004 may respond with a BA frame 1024 to data frame 1018.

STA 1006 may not access the medium at least during quiet interval 1022 indicated in beacon frame 1008. When quiet interval 1022 or r-TWT SP 1020 ends, STA 1006 may resume transmission by transmitting a data frame 1026. STA 1004 may return to the doze state at the end of r-TWT SP 1020.

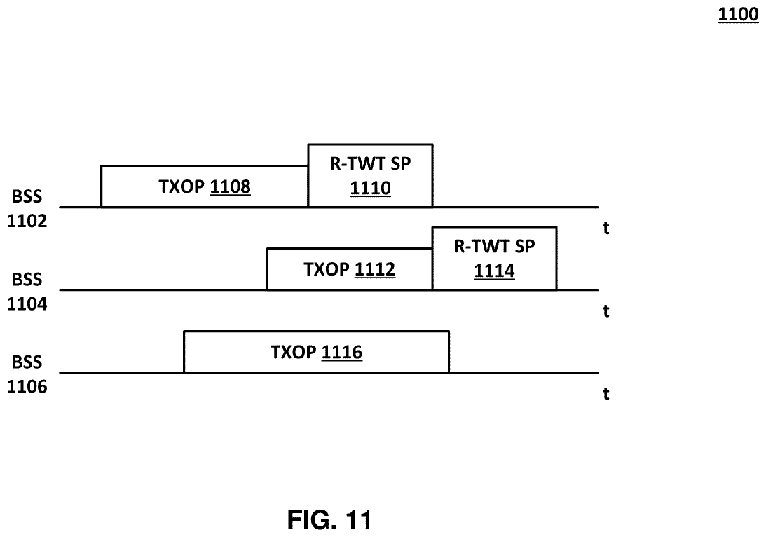

FIG. 11 is an example 1100 that illustrates inter-basic service set (BSS) interference due to overlap between a transmission opportunity (TXOP) of a BSS with r-TWT service periods (SPs) of overlapping BSSs. As shown in FIG. 11, example 1100 includes three BSSs, BSS 1102, BSS 1102, and BSS 1106. BSSs 1102, 1104, and 1106 may be overlapping BSSs. That is, BSSs 1102, 1104, and 1106 may be neighboring BSSs that operate over the same channel and may as such cause interference to one another.

In example 1100, an r-TWT SP 1110 and an r-TWT SP 1114 may be scheduled in BSS 1102 and BSS 1104, respectively. Within BSS 1102, a TXOP 1108 initiated by an r-TWT supporting STA (not shown in FIG. 11) before r-TWT SP 1110 is ended by the r-TWT supporting STA before the start of r-TWT SP 1110 according to existing r-TWT operation as described above. Similarly, within BSS 1104, a TXOP 1112 initiated by an r-TWT supporting STA (not shown in FIG. 11) before r-TWT SP 1114 is ended by the r-TWT supporting STA before the start of r-TWT SP 1114.

However, according to existing r-TWT operation rules, an r-TWT supporting AP/STA in a given BSS is not required to end an initiated TXOP before the start time of an r-TWT SP scheduled in another BSS. As such, as shown in FIG. 11, TXOP 1112 within BSS 1104 may extend into r-TWT SP 1110 scheduled in BSS 1102. Similarly, TXOP 1116 within BSS 1106 may extend into r-TWT SP 1110 scheduled in BSS 1102 and/or r-TWT SP 1114 scheduled in BSS 1104. This may cause interference to and/or delayed transmission of r-TWT traffic (which may include latency sensitive traffic) within r-TWT SP 1110 and/or r-TWT SP 1114.

To enhance the delivery of latency sensitive traffic, coordinated medium access (CMA) has been proposed to allow APs of neighboring BSSs to coordinate their medium access. Two levels of coordination are envisioned. According to a first coordination level (level 1 CMA), an AP of a given BSS may end a TXOP that it initiates before the start of an SP scheduled in another BSS (called coordinated SP). To reduce contention from its associated STAs, the AP may set up trigger-enabled r-TWT SPs and/or use multi-user (MU) enhanced distributed channel access (EDCA) in the BSS. According to a second coordination level (level 2 CMA), the AP may announce the coordinated SP to its associated STAs and a STA may also end a TXOP that it initiates before the start of a coordinated SP scheduled in another BSS. In an implementation, the AP may announce the coordinated SP as an r-TWT SP and r-TWT supporting STAs associated with the AP may end an initiated TXOP before the start of the r-TWT SP.

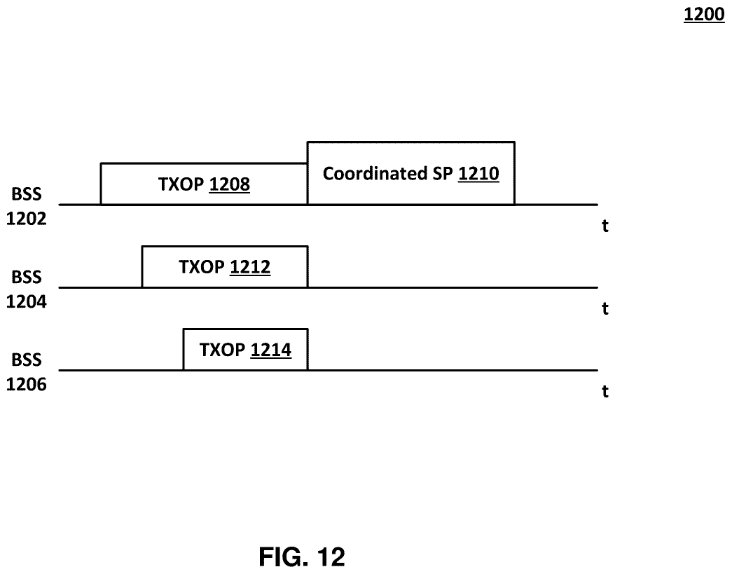

FIG. 12 is an example 1200 that illustrates the use of CMA to reduce the inter-BSS interference illustrated in FIG. 11. As shown in FIG. 12, example 1200 includes three BSSs, BSS 1202, BSS 1204, and BSS 1206. BSSs 1202, 1204, and 1206 may be overlapping BSSs.

In example 1200, an AP of BSS 1202 may schedule a coordinated SP 1210 in BSS 1102 and may announce coordinated SP 1210 in a beacon frame (not shown in FIG. 12) transmitted prior to the start of coordinated SP 1210. APs of BSSs 1204 and 1206 may receive the beacon frame and may announce coordinated SP 1210 to their respective associated STAs. In BSS 1202, the AP or an r-TWT supporting STA may end a TXOP 1208 before the start of SP 1210. In BSSs 1204 and 1206, TXOPs 1212 and 1214 respectively may also be ended before the start of coordinated SP 1210. TXOPs 1212 and 1214 may be ended by initiating APs only when level 1 CMA is used and by both initiating APs and initiating STAs when level 2 CMA is used.

As described above, one requirement for proper CMA operation is that an AP of a given BSS successfully receives the beacon frame transmitted by another AP of another BSS, in order for the AP to learn of the scheduling of a coordinated SP in the other BSS. The AP however may not be able to receive the beacon frame transmitted by the other AP if a STA associated with the AP transmits a frame to the AP at the time of transmission of the beacon frame by the other AP. Embodiments of the present disclosure, as further described below, address this potential problem that may arise in a BSS and that may preclude CMA among overlapping BSSs.

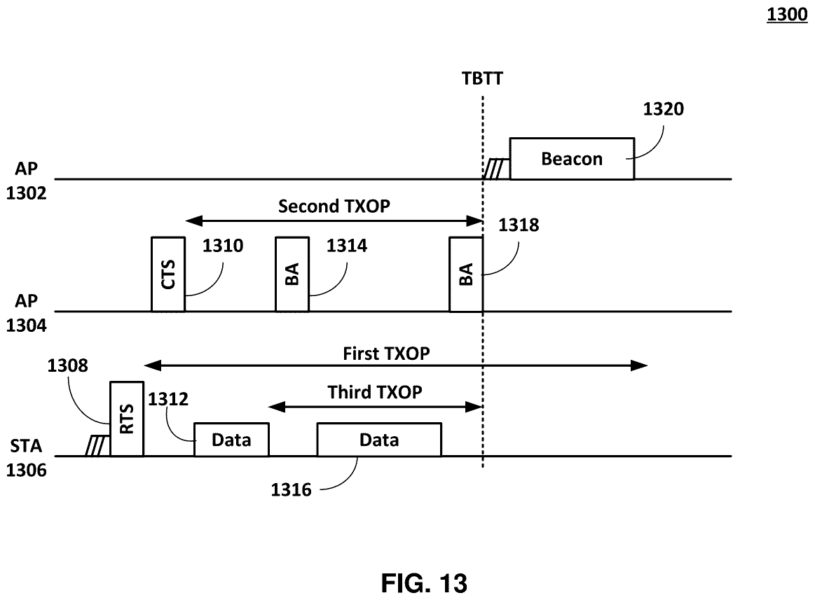

FIG. 13 is an example 1300 that illustrates a proposed channel access procedure according to an embodiment of the present disclosure. As shown in FIG. 13, example 1300 includes AP 1302 and 1304 and a STA 1306. APs 1302 and 1304 may be within communication range of one another. For example, APs 1302 and 1304 may be overlapping basis service set (OBSS) APs relative to one another. APs 1302 and 1304 may or may not be part of a multi-AP group. STA 1306 may be associated with AP 1304. AP 1302 and STA 1306 may or may not be within communication range of one another. AP 1302, AP 1304, and/or STA 1306 may support CMA. In an embodiment, supporting CMA comprises AP 1302, AP 1304, and/or STA 1306 ending a TXOP before a start time of an R-TWT SP of an OBSS AP.

As shown in FIG. 13, example 1300 may begin with STA 1306 transmitting an RTS frame 1308 to AP 1304. RTS frame 1308 may indicate a first TXOP. In an embodiment, as shown in FIG. 13, the first TXOP starts from an end time of transmission of RTS frame 1308. In an embodiment, RTS frame 1308 comprises a TXOP field that indicates a duration of the first TXOP. The TXOP field may be a field of a PHY header of RTS frame 1308. For example, the TXOP field may be a field of an HE-SIG-A field of the PHY header of RTS frame 1308. In an embodiment, the indication of the first TXOP in the TXOP field is obtained by converting the value of a TXVECTOR parameter TXOP_DURATION as described in section 26.11.5 of the IEEE 802.11 standard (“IEEE P802.11-REVme/D3.0, April 2023.”) Alternatively, or additionally, RTS frame 1308 may comprise a duration field that indicates the duration of the first TXOP. The duration field may be a field of a MAC header of RTS frame 1308.

AP 1304 may receive RTS frame 1308 from STA 1306. In an embodiment, AP 1304 may be configured to determine whether the first TXOP indicated in RTS frame 1308 overlaps (in time) with a TBTT of a neighboring AP. The neighboring AP may or may not be part of a multi-AP group that AP 1304 belongs to. In example 1300, AP 1304 may determine that the first TXOP indicated in RTS frame 1308 overlaps with a TBTT of AP 1302. For example, as shown in FIG. 13, the first TXOP may extend beyond the TBTT of AP 1302.

In an embodiment, based on the first TXOP indicated in RTS frame 1308 overlapping with the TBTT of AP 1302, AP 1304 may respond to RTS frame 1308 by transmitting to STA 1306 a CTS frame 1310 that indicates a second TXOP. In an embodiment, AP 1304 transmits CTS frame 1310 a time period after receiving RTS frame 1308. In an embodiment, the time period is equal to a short interframe space (SIFS).

In an embodiment, as shown in FIG. 13, the second TXOP starts from an end time of transmission of CTS frame 1310. In an embodiment, CTS frame 1310 comprises a TXOP field that indicates a duration of the second TXOP. The TXOP field may be a field of a PHY header of CTS frame 1310. For example, the TXOP field may be a field of an HE-SIG-A field of the PHY header of CTS frame 1310. In an embodiment, the indication of the second TXOP in the TXOP field is obtained by converting the value of a TXVECTOR parameter TXOP_DURATION as described in section 26.11.5 of the IEEE 802.11 standard. Alternatively, or additionally, CTS frame 1310 may comprise a duration field that indicates the duration of the second TXOP. The duration field may be a field of a MAC header of CTS frame 1310.

In an embodiment, the second TXOP is different from the first TXOP. In an embodiment, the second TXOP does not overlap with the TBTT of AP 1302. In an embodiment, the second TXOP may have a different start time, a different duration, and/or a different end time than the first TXOP.

In an embodiment, CTS frame 1310 comprises a field indicating presence of the second TXOP. The field indicating the presence of the second TXOP may comprise a duration field or a TXOP field of CTS frame 1310.

In an embodiment, AP 1302 may receive CTS frame 1310. In an embodiment, AP 1302 may update its NAV based on the second TXOP indicated in CTS frame 1310. In an embodiment, an AP, such as AP 1302, supporting CMA may be configured to update its NAV set based on a first TXOP indicated in a first frame (e.g., RTS frame 1308) based on a second TXOP indicated in a second frame (e.g., CTS frame 1310) if the second frame is transmitted a SIFS after the first frame. In an embodiment, AP 1302 may not receive the first frame but may receive the second frame.

In an embodiment, based on receiving CTS frame 1310 indicating the second TXOP, STA 1306 may transmit a data frame 1312 indicating a third TXOP. In an embodiment, as shown in FIG. 13, the third TXOP starts from an end time of transmission of data frame 1312. In an embodiment, data frame 1312 comprises a TXOP field that indicates a duration of the third TXOP. The TXOP field may be a field of a PHY header of data frame 1312. For example, the TXOP field may be a field of an HE-SIG-A field of the PHY header of data frame 1312. In an embodiment, the indication of the third TXOP in the TXOP field is obtained by converting the value of a TXVECTOR parameter TXOP_DURATION as described in section 26.11.5 of the IEEE 802.11 standard. Alternatively, or additionally, data frame 1312 may comprise a duration field that indicates the third TXOP. The duration field may be a field of a MAC header of data frame 1312. AP 1304 may transmit a BA frame 1314 to STA 1306 in response to data frame 1312.

In an embodiment, as shown in FIG. 13, the third TXOP may have a same end time as the second TXOP indicated in CTS frame 1310. As such, the third TXOP may not overlap with the TBTT of AP 1302. In an example, as shown in FIG. 13, STA 1306 may transmit a further data frame 1316 to AP 1304 and AP 1304 may respond with a BA frame 1318 to STA 1306 within the third TXOP. Subsequently, at the TBTT of AP 1302, AP 1302 may transmit a beacon frame 1320 after performing a random backoff. As the third TXOP ends before the TBTT of AP 1302, AP 1304 may be available at the time of transmission of beacon frame 1320 and may thus successfully receive beacon frame 1320. Based on successfully receiving beacon frame 1320, AP 1304 may be able to perform CMA with AP 1302.

In an embodiment, to avoid having STA 1306 attempt to access the wireless medium immediately after the end of the third TXOP, STA 1306 may be configured to defer channel access using EDCA for a specific time period after the end of the third TXOP. Alternatively, or additionally, STA 1306 may be configured to use different EDCA parameters during a specific time period after the end of the third TXOP, where the different EDCA parameters are configured to reduce the possibility of STA 1306 gaining access to the wireless medium during the specific time period. For example, STA 1306 may use multi-user (MU) EDCA parameters as the different EDCA parameters during the specific time period. The MU EDCA parameters may be as defined in the existing IEEE 802.11 standard (e.g., IEEE 802.11ax standard).

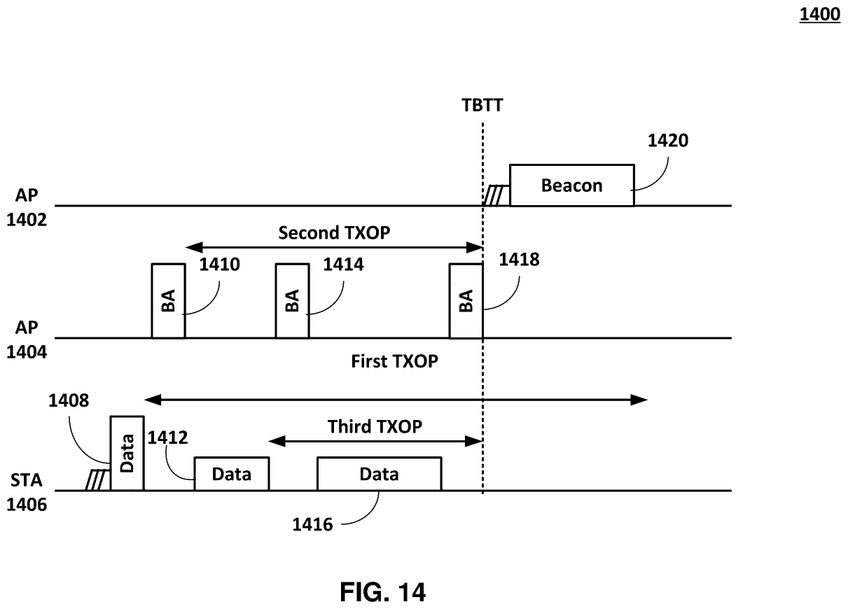

FIG. 14 is an example 1400 that illustrates another proposed channel access procedure according to an embodiment of the present disclosure. As shown in FIG. 14, example 1400 includes AP 1402 and 1404 and a STA 1406. APs 1402 and 1404 may be within communication range of one another. For example, APs 1402 and 1404 may be OBSS APs relative to one another. APs 1402 and 1404 may or may not be part of a multi-AP group. STA 1406 may be associated with AP 1404. AP 1402 and STA 1406 may or may not be within communication range of one another. AP 1402, AP 1404, and/or STA 1406 may support CMA. In an embodiment, supporting CMA comprises AP 1402, AP 1404, and/or STA 1406 ending a TXOP before a start time of an R-TWT SP of an OBSS AP.

As shown in FIG. 14, example 1400 may begin with STA 1406 transmitting a data frame 1408 to AP 1404. Data frame 1408 may indicate a first TXOP. In an embodiment, as shown in FIG. 14, the first TXOP starts from an end time of transmission of data frame 1408. In an embodiment, data frame 1408 comprises a TXOP field that indicates a duration of the first TXOP. The TXOP field may be a field of a PHY header of data frame 1408. For example, the TXOP field may be a field of an HE-SIG-A field of the PHY header of data frame 1408. In an embodiment, the indication of the first TXOP in the TXOP field is obtained by converting the value of a TXVECTOR parameter TXOP_DURATION as described in section 26.11.5 of the IEEE 802.11 standard (“IEEE P802.11-REVme/D3.0, April 2023.”) Alternatively, or additionally, data frame 1408 may comprise a duration field that indicates the duration of the first TXOP. The duration field may be a field of a MAC header of data frame 1408.

AP 1404 may receive data frame 1408 from STA 1406. In an embodiment, AP 1404 may be configured to determine whether the first TXOP indicated in data frame 1408 overlaps (in time) with a TBTT of a neighboring AP. The neighboring AP may or may not be part of a multi-AP group that AP 1404 belongs to. In example 1400, AP 1404 may determine that the first TXOP indicated in data frame 1408 overlaps with a TBTT of AP 1402. For example, as shown in FIG. 14, the first TXOP may extend beyond the TBTT of AP 1402.

In an embodiment, based on the first TXOP indicated in data frame 1408 overlapping with the TBTT of AP 1402, AP 1404 may respond to data frame 1408 by transmitting to STA 1406 a BA frame 1410 that indicates a second TXOP. In an embodiment, AP 1404 transmits BA frame 1410 a time period after receiving data frame 1408. In an embodiment, the time period is equal to a SIFS.

In an embodiment, as shown in FIG. 14, the second TXOP starts from an end time of transmission of BA frame 1410. In an embodiment, BA frame 1410 comprises a TXOP field that indicates a duration of the second TXOP. The TXOP field may be a field of a PHY header of BA frame 1410. For example, the TXOP field may be a field of an HE-SIG-A field of the PHY header of BA frame 1410. In an embodiment, the indication of the second TXOP in the TXOP field is obtained by converting the value of a TXVECTOR parameter TXOP_DURATION as described in section 26.11.5 of the IEEE 802.11 standard. Alternatively, or additionally, BA frame 1410 may comprise a duration field that indicates the duration of the second TXOP. The duration field may be a field of a MAC header of BA frame 1410.

In an embodiment, the second TXOP is different from the first TXOP. In an embodiment, the second TXOP does not overlap with the TBTT of AP 1402. In an embodiment, the second TXOP may have a different start time, a different duration, and/or a different end time than the first TXOP.

In an embodiment, BA frame 1410 comprises a field indicating presence of the second TXOP. The field indicating the presence of the second TXOP may comprise a duration field or a TXOP field of BA frame 1410.

In an embodiment, AP 1402 may receive BA frame 1410. In an embodiment, AP 1402 may update its NAV based on the second TXOP indicated in BA frame 1410.

In an embodiment, based on receiving BA frame 1410 indicating the second TXOP, STA 1406 may transmit a data frame 1412 indicating a third TXOP. In an embodiment, as shown in FIG. 14, the third TXOP starts from an end time of transmission of data frame 1412. In an embodiment, data frame 1412 comprises a TXOP field that indicates a duration of the third TXOP. The TXOP field may be a field of a PHY header of data frame 1412. For example, the TXOP field may be a field of an HE-SIG-A field of the PHY header of data frame 1412. In an embodiment, the indication of the third TXOP in the TXOP field is obtained by converting the value of a TXVECTOR parameter TXOP_DURATION as described in section 26.11.5 of the IEEE 802.11 standard. Alternatively, or additionally, data frame 1412 may comprise a duration field that indicates the third TXOP. The duration field may be a field of a MAC header of data frame 1412. AP 1404 may transmit a BA frame 1414 to STA 1406 in response to data frame 1412.

In an embodiment, as shown in FIG. 14, the third TXOP may have a same end time as the second TXOP indicated in BA frame 1410. As such, the third TXOP may not overlap with the TBTT of AP 1402. In an example, as shown in FIG. 14, STA 1406 may transmit a further data frame 1416 to AP 1404 and AP 1404 may respond with a BA frame 1418 to STA 1406 within the third TXOP. Subsequently, at the TBTT of AP 1402, AP 1402 may transmit a beacon frame 1420 after performing a random backoff. As the third TXOP ends before the TBTT of AP 1402, AP 1404 may be available at the time of transmission of beacon frame 1420 and may thus successfully receive beacon frame 1420. Based on successfully receiving beacon frame 1420, AP 1404 may be able to perform CMA with AP 1402.

In an embodiment, to avoid having STA 1406 attempt to access the wireless medium immediately after the end of the third TXOP, STA 1406 may be configured to defer channel access using EDCA for a specific time period after the end of the third TXOP. Alternatively, or additionally, STA 1406 may be configured to use different EDCA parameters during a specific time period after the end of the third TXOP, where the different EDCA parameters are configured to reduce the possibility of STA 1406 gaining access to the wireless medium during the specific time period.

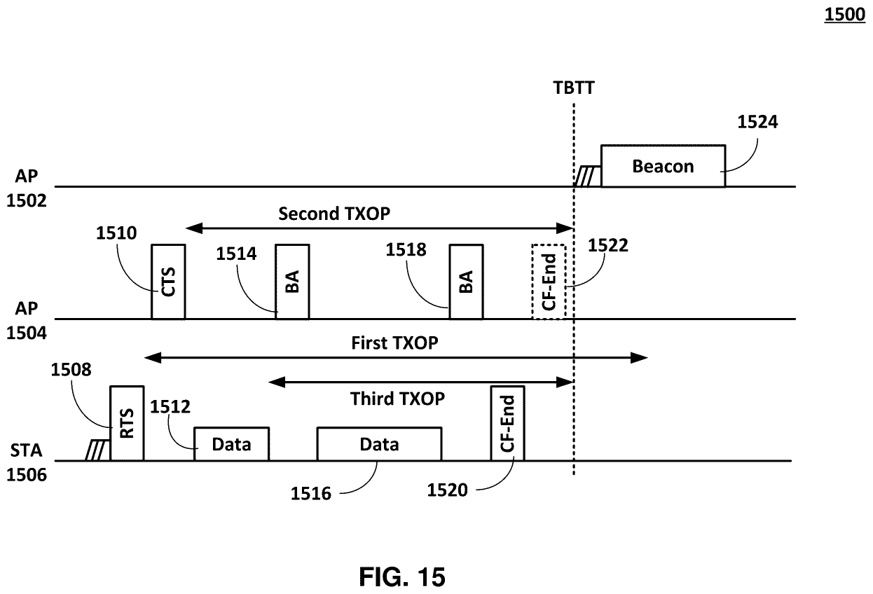

FIG. 15 is an example 1500 that illustrates another proposed channel access procedure according to an embodiment of the present disclosure. As shown in FIG. 15, example 1500 includes AP 1502 and 1504 and a STA 1506. APs 1502 and 1504 may be within communication range of one another. For example, APs 1502 and 1504 may be OBSS APs relative to one another. APs 1502 and 1504 may or may not be part of a multi-AP group. STA 1506 may be associated with AP 1504. AP 1502 and STA 1506 may or may not be within communication range of one another. AP 1502, AP 1504, and/or STA 1506 may support CMA. In an embodiment, supporting CMA comprises AP 1502, AP 1504, and/or STA 1506 ending a TXOP before a start time of an R-TWT SP of an OBSS AP.

As shown in FIG. 15, example 1500 may begin with STA 1506 transmitting an RTS frame 1508 to AP 1504. RTS frame 1508 may indicate a first TXOP. In an embodiment, as shown in FIG. 15, the first TXOP starts from an end time of transmission of RTS frame 1508. In an embodiment, RTS frame 1508 comprises a TXOP field that indicates a duration of the first TXOP. The TXOP field may be a field of a PHY header of RTS frame 1508. For example, the TXOP field may be a field of an HE-SIG-A field of the PHY header of RTS frame 1508. In an embodiment, the indication of the first TXOP in the TXOP field is obtained by converting the value of a TXVECTOR parameter TXOP_DURATION as described in section 26.11.5 of the IEEE 802.11 standard (“IEEE P802.11-REVme/D3.0, April 2023.”) Alternatively, or additionally, RTS frame 1508 may comprise a duration field that indicates the duration of the first TXOP. The duration field may be a field of a MAC header of RTS frame 1508.

AP 1504 may receive RTS frame 1508 from STA 1506. In an embodiment, AP 1504 may be configured to determine whether the first TXOP indicated in RTS frame 1508 overlaps (in time) with a TBTT of a neighboring AP. The neighboring AP may or may not be part of a multi-AP group that AP 1504 belongs to. In example 1500, AP 1504 may determine that the first TXOP indicated in RTS frame 1508 overlaps with a TBTT of AP 1502. For example, as shown in FIG. 15, the first TXOP may extend beyond the TBTT of AP 1502.

In an embodiment, based on the first TXOP indicated in RTS frame 1508 overlapping with the TBTT of AP 1502, AP 1504 may respond to RTS frame 1508 by transmitting to STA 1506 a CTS frame 1510 that indicates a second TXOP. In an embodiment, AP 1504 transmits CTS frame 1510 a time period after receiving RTS frame 1508. In an embodiment, the time period is equal to a short interframe space (SIFS).

In an embodiment, as shown in FIG. 15, the second TXOP starts from an end time of transmission of CTS frame 1510. In an embodiment, CTS frame 1510 comprises a TXOP field that indicates a duration of the second TXOP. The TXOP field may be a field of a PHY header of CTS frame 1510. For example, the TXOP field may be a field of an HE-SIG-A field of the PHY header of CTS frame 1510. In an embodiment, the indication of the second TXOP in the TXOP field is obtained by converting the value of a TXVECTOR parameter TXOP_DURATION as described in section 26.11.5 of the IEEE 802.11 standard. Alternatively, or additionally, CTS frame 1510 may comprise a duration field that indicates the duration of the second TXOP. The duration field may be a field of a MAC header of CTS frame 1510.

In an embodiment, the second TXOP is different from the first TXOP. In an embodiment, the second TXOP does not overlap with the TBTT of AP 1502. In an embodiment, the second TXOP may have a different start time, a different duration, and/or a different end time than the first TXOP.

In an embodiment, CTS frame 1510 comprises a field indicating presence of the second TXOP. The field indicating the presence of the second TXOP may comprise a duration field or a TXOP field of CTS frame 1510.

In an embodiment, AP 1502 may receive CTS frame 1510. In an embodiment, AP 1502 may update its NAV based on the second TXOP indicated in CTS frame 1510. In an embodiment, an AP, such as AP 1502, supporting CMA may be configured to update its NAV set based on a first TXOP indicated in a first frame (e.g., RTS frame 1508) based on a second TXOP indicated in a second frame (e.g., CTS frame 1510) if the second frame is transmitted a SIFS after the first frame.

In an embodiment, based on receiving CTS frame 1510 indicating the second TXOP, STA 1506 may transmit a data frame 1512 indicating a third TXOP. In an embodiment, as shown in FIG. 15, the third TXOP starts from an end time of transmission of data frame 1512. In an embodiment, data frame 1512 comprises a TXOP field that indicates a duration of the third TXOP. The TXOP field may be a field of a PHY header of data frame 1512. For example, the TXOP field may be a field of an HE-SIG-A field of the PHY header of data frame 1512. In an embodiment, the indication of the third TXOP in the TXOP field is obtained by converting the value of a TXVECTOR parameter TXOP_DURATION as described in section 26.11.5 of the IEEE 802.11 standard. Alternatively, or additionally, data frame 1512 may comprise a duration field that indicates the third TXOP. The duration field may be a field of a MAC header of data frame 1512. AP 1504 may transmit a BA frame 1514 to STA 1506 in response to data frame 1512.

In an embodiment, as shown in FIG. 15, the third TXOP may have a same end time as the second TXOP indicated in CTS frame 1510. As such, the third TXOP may not overlap with the TBTT of AP 1502. In an example, as shown in FIG. 15, STA 1506 may transmit a further data frame 1516 to AP 1504 and AP 1504 may respond with a BA frame 1518 to STA 1506 within the third TXOP.

In an embodiment, when STA 1506 has no more data frame to transmit, and if the third TXOP has not ended, STA 1506 may transmit a contention free (CF)-End frame 1520. CF-End frame 1520 allows an AP or STA that hears it to reset its NAV. As such, STA 1506 may truncate the third TXOP for APs/STAs within its communication range. In another embodiment, additionally or alternatively, AP 1504 may transmit a CF-End frame 1522. CF-End frame 1522 allows an AP or STA that hears it to reset its NAV. As such, AP 1504 may truncate the third TXOP for APs/STAs within its communication range. In an embodiment, AP 1502 may reset its NAV based on CF-End frame 1520 or CF-End frame 1522. As would be understood by a person of skill in the art based on the teachings herein, the transmission of CF-End frame(s) as described herein may similarly be used in the embodiment of FIG. 14.

Subsequently, at the TBTT of AP 1502, AP 1502 may transmit a beacon frame 1524 after performing a random backoff. As the third TXOP ends before the TBTT of AP 1502, AP 1504 may be available at the time of transmission of beacon frame 1524 and may thus successfully receive beacon frame 1524. Based on successfully receiving beacon frame 1524, AP 1504 may be able to perform CMA with AP 1502.

In an embodiment, to avoid having STA 1506 attempt to access the wireless medium immediately after the end of the third TXOP, STA 1506 may be configured to defer channel access using EDCA for a specific time period after the end of the third TXOP. Alternatively, or additionally, STA 1506 may be configured to use different EDCA parameters during a specific time period after the end of the third TXOP, where the different EDCA parameters are configured to reduce the possibility of STA 1506 gaining access to the wireless medium during the specific time period.

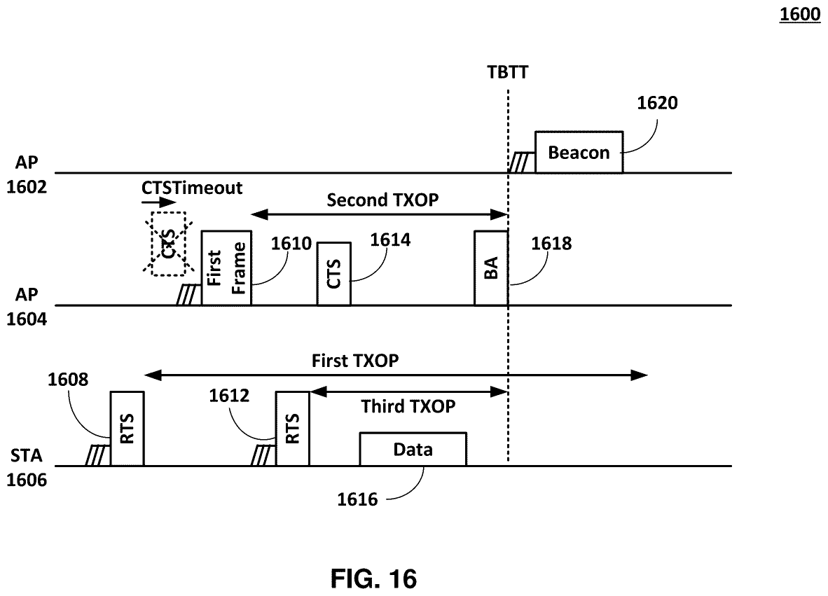

FIG. 16 is an example 1600 that illustrates another proposed channel access procedure according to an embodiment of the present disclosure. As shown in FIG. 16, example 1600 includes AP 1602 and 1604 and a STA 1606. APs 1602 and 1604 may be within communication range of one another. For example, APs 1602 and 1604 may be overlapping basis service set (OBSS) APs relative to one another. APs 1602 and 1604 may or may not be part of a multi-AP group. STA 1606 may be associated with AP 1604. AP 1602 and STA 1606 may or may not be within communication range of one another. AP 1602, AP 1604, and/or STA 1606 may support CMA. In an embodiment, supporting CMA comprises AP 1602, AP 1604, and/or STA 1606 ending a TXOP before a start time of an R-TWT SP of an OBSS AP.

As shown in FIG. 16, example 1600 may begin with STA 1606 transmitting an RTS frame 1608 to AP 1604. RTS frame 1608 may indicate a first TXOP. In an embodiment, as shown in FIG. 16, the first TXOP starts from an end time of transmission of RTS frame 1608. In an embodiment, RTS frame 1608 comprises a TXOP field that indicates a duration of the first TXOP. The TXOP field may be a field of a PHY header of RTS frame 1608. For example, the TXOP field may be a field of an HE-SIG-A field of the PHY header of RTS frame 1608. In an embodiment, the indication of the first TXOP in the TXOP field is obtained by converting the value of a TXVECTOR parameter TXOP_DURATION as described in section 26.11.5 of the IEEE 802.11 standard (“IEEE P802.11-REVme/D3.0, April 2023.”) Alternatively, or additionally, RTS frame 1608 may comprise a duration field that indicates the duration of the first TXOP. The duration field may be a field of a MAC header of RTS frame 1608.

AP 1604 may receive RTS frame 1608 from STA 1606. In an embodiment, AP 1604 may be configured to determine whether the first TXOP indicated in RTS frame 1608 overlaps (in time) with a TBTT of a neighboring AP. The neighboring AP may or may not be part of a multi-AP group that AP 1604 belongs to. In example 1600, AP 1604 may determine that the first TXOP indicated in RTS frame 1608 overlaps with a TBTT of AP 1602. For example, as shown in FIG. 16, the first TXOP may extend beyond the TBTT of AP 1602.

In an embodiment, based on the first TXOP indicated in RTS frame 1608 overlapping with the TBTT of AP 1602, AP 1604 may be configured to not respond to RTS frame 1608 by transmitting to STA 1606 a CTS frame (even when the NAV of AP 1604 indicates idle). Instead, AP 1604 may be configured to transmit a first frame 1610 indicating a second TXOP a time period after receiving RTS frame 1608. In an embodiment, the time period is equal to a CTS timeout interval or to the CTS timeout interval plus an xIFS. In an embodiment, the CTS timeout interval is equal to aSIFSTime+aRxPHYStartDelay+aSlotTime. In an embodiment, the xIFS is equal to a distributed interframe space (DIFS), a priority interframe space (PIFS), a short interframe space (SIFS), or an arbitrary interframe space (AIFS).

In an embodiment, first frame 1610 may be a control frame or a QoS null frame. The control frame may comprise a field indicating the second TXOP. The QoS null frame may comprise an aggregated control (A-Control) field that indicates the second TXOP.

In an embodiment, as shown in FIG. 16, the second TXOP starts from an end time of transmission of first frame 1610. In an embodiment, first frame 1610 comprises a TXOP field that indicates a duration of the second TXOP. The TXOP field may be a field of a PHY header of first frame 1610. For example, the TXOP field may be a field of an HE-SIG-A field of the PHY header of first frame 1610. In an embodiment, the indication of the second TXOP in the TXOP field is obtained by converting the value of a TXVECTOR parameter TXOP_DURATION as described in section 26.11.5 of the IEEE 802.11 standard. Alternatively, or additionally, first frame 1610 may comprise a duration field that indicates the duration of the second TXOP. The duration field may be a field of a MAC header of first frame 1610.

In an embodiment, the second TXOP is different from the first TXOP. In an embodiment, the second TXOP does not overlap with the TBTT of AP 1602. In an embodiment, the second TXOP may have a different start time, a different duration, and/or a different end time than the first TXOP.

In an embodiment, first frame 1610 comprises a field indicating presence of the second TXOP. The field indicating the presence of the second TXOP may comprise a duration field or a TXOP field of first frame 1610.

In an embodiment, AP 1602 may receive first frame 1610. In an embodiment, AP 1602 may update its NAV based on the second TXOP indicated in first frame 1610.

In an embodiment, based on receiving first frame 1610 indicating the second TXOP, STA 1606 may transmit an RTS frame 1612 indicating a third TXOP. In an embodiment, as shown in FIG. 16, the third TXOP starts from an end time of transmission of RTS frame 1612. In an embodiment, RTS frame 1612 comprises a TXOP field that indicates a duration of the third TXOP. The TXOP field may be a field of a PHY header of RTS frame 1612. For example, the TXOP field may be a field of an HE-SIG-A field of the PHY header of RTS frame 1612. In an embodiment, the indication of the third TXOP in the TXOP field is obtained by converting the value of a TXVECTOR parameter TXOP_DURATION as described in section 26.11.5 of the IEEE 802.11 standard. Alternatively, or additionally, RTS frame 1612 may comprise a duration field that indicates the third TXOP. The duration field may be a field of a MAC header of RTS frame 1612.

In an embodiment, as shown in FIG. 16, the third TXOP may have a same end time as the second TXOP indicated in first frame 1610. As such, the third TXOP may not overlap with the TBTT of AP 1602.

AP 1604 may transmit a CTS frame 1614 to STA 1606 in response to RTS frame 1612. Subsequently, as shown in FIG. 16, STA 1606 may transmit a data frame 1616 to AP 1604 and AP 1604 may respond with a BA frame 1618 to STA 1606 within the third TXOP. In an embodiment, STA 1606 and/or AP 1604 may transmit a CF-End frame to truncate the third TXOP as described above with reference to FIG. 15.

Subsequently, at the TBTT of AP 1602, AP 1602 may transmit a beacon frame 1620 after performing a random backoff. As the third TXOP ends before the TBTT of AP 1602, AP 1604 may be available at the time of transmission of beacon frame 1620 and may thus successfully receive beacon frame 1620. Based on successfully receiving beacon frame 1620, AP 1604 may be able to perform CMA with AP 1602.

In an embodiment, to avoid having STA 1606 attempt to access the wireless medium immediately after the end of the third TXOP, STA 1606 may be configured to defer channel access using EDCA for a specific time period after the end of the third TXOP. Alternatively, or additionally, STA 1606 may be configured to use different EDCA parameters during a specific time period after the end of the third TXOP, where the different EDCA parameters are configured to reduce the possibility of STA 1606 gaining access to the wireless medium during the specific time period.

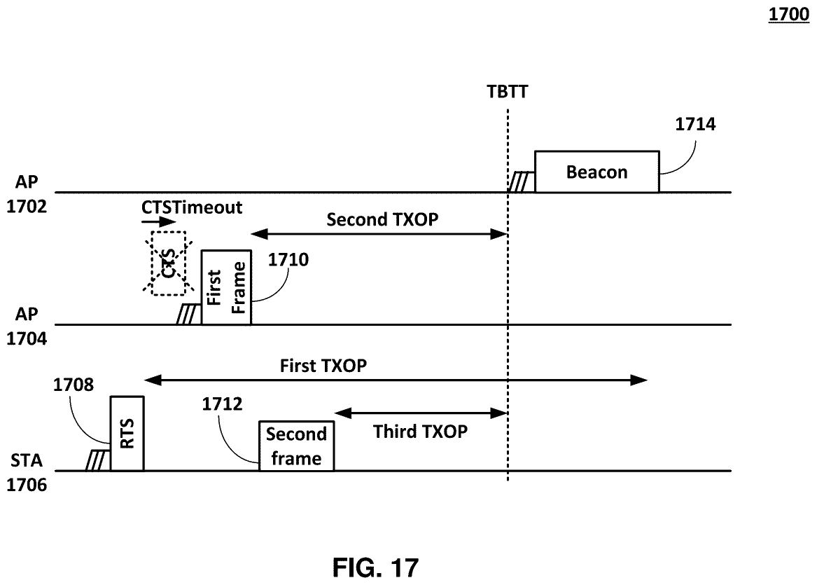

FIG. 17 is an example 1700 that illustrates another proposed procedure according to an embodiment of the present disclosure. As shown in FIG. 17, example 1700 includes AP 1702 and 1704 and a STA 1706. APs 1702 and 1704 may be within communication range of one another. For example, APs 1702 and 1704 may be OBSS APs relative to one another. APs 1702 and 1704 may or may not be part of a multi-AP group. STA 1706 may be associated with AP 1704. AP 1702, AP 1704, and/or STA 1706 may support CMA. In an embodiment, supporting CMA comprises AP 1702, AP 1704, and/or STA 1706 ending a TXOP before a start time of an R-TWT SP of an OBSS AP.

As shown in FIG. 17, example 1700 may begin with STA 1706 transmitting an RTS frame 1708 to AP 1704. RTS frame 1708 may indicate a first TXOP. In an embodiment, as shown in FIG. 17, the first TXOP starts from an end time of transmission of RTS frame 1708. In an embodiment, RTS frame 1708 comprises a TXOP field that indicates a duration of the first TXOP. The TXOP field may be a field of a PHY header of RTS frame 1708. For example, the TXOP field may be a field of an HE-SIG-A field of the PHY header of RTS frame 1708. In an embodiment, the indication of the first TXOP in the TXOP field is obtained by converting the value of a TXVECTOR parameter TXOP_DURATION as described in section 26.11.5 of the IEEE 802.11 standard (“IEEE P802.11-REVme/D3.0, April 2023.”) Alternatively, or additionally, RTS frame 1708 may comprise a duration field that indicates the duration of the first TXOP. The duration field may be a field of a MAC header of RTS frame 1708.

AP 1704 may receive RTS frame 1708 from STA 1706. In an embodiment, AP 1704 may be configured to determine whether the first TXOP indicated in RTS frame 1708 overlaps (in time) with a TBTT of a neighboring AP. The neighboring AP may or may not be part of a multi-AP group that AP 1704 belongs to. In example 1700, AP 1704 may determine that the first TXOP indicated in RTS frame 1708 overlaps with a TBTT of AP 1702. For example, as shown in FIG. 17, the first TXOP may extend beyond the TBTT of AP 1702.

In an embodiment, based on the first TXOP indicated in RTS frame 1708 overlapping with the TBTT of AP 1702, AP 1704 may be configured to not respond to RTS frame 1708 by transmitting to STA 1706 a CTS frame (even when the NAV of AP 1704 indicates idle). Instead, AP 1704 may be configured to transmit a first frame 1710 indicating a second TXOP a time period after receiving RTS frame 1708. In an embodiment, the time period is equal to a CTS timeout interval or to the CTS timeout interval plus an xIFS. In an embodiment, the CTS timeout interval is equal to aSIFSTime+aRxPHYStartDelay+aSlotTime. In an embodiment, the xIFS is equal to a DIFS, a PIFS, a SIFS, or an AIFS.

In an embodiment, first frame 1710 may be a multi-user (MU) RTS Triggered TXOP Sharing (TXS) (MRTT) frame, a trigger frame, or a poll frame.

In an embodiment, as shown in FIG. 17, the second TXOP starts from an end time of transmission of first frame 1710. In an embodiment, first frame 1710 comprises a TXOP field that indicates a duration of the second TXOP. The TXOP field may be a field of a PHY header of first frame 1710. For example, the TXOP field may be a field of an HE-SIG-A field of the PHY header of first frame 1710. In an embodiment, the indication of the second TXOP in the TXOP field is obtained by converting the value of a TXVECTOR parameter TXOP_DURATION as described in section 26.11.5 of the IEEE 802.11 standard. Alternatively, or additionally, first frame 1710 may comprise a duration field that indicates the duration of the second TXOP. The duration field may be a field of a MAC header of first frame 1710.

In an embodiment, the second TXOP is different from the first TXOP. In an embodiment, the second TXOP does not overlap with the TBTT of AP 1702. In an embodiment, the second TXOP may have a different start time, a different duration, and/or a different end time than the first TXOP.

In an embodiment, first frame 1710 comprises a field indicating presence of the second TXOP. The field indicating the presence of the second TXOP may comprise a duration field or a TXOP field of first frame 1710.

In an embodiment, AP 1702 may receive first frame 1710. In an embodiment, AP 1702 may update its NAV based on the second TXOP indicated in first frame 1710.

In an embodiment, based on receiving first frame 1710 indicating the second TXOP, STA 1706 may transmit a second frame 1712 indicating a third TXOP. STA 1706 may transmit second frame 1712 a SIFS from receiving first frame 1710. In an embodiment, where first frame 1710 is an MRTT frame, second frame 1712 may be a CTS frame. In an embodiment, where second frame 1712 is a trigger frame, second frame 1712 may be a TB PPDU. In an embodiment, where first frame 1710 is a poll frame, second frame 1712 may be a non-TB PPDU.

In an embodiment, as shown in FIG. 17, the third TXOP starts from an end time of transmission of second frame 1712. In an embodiment, second frame 1712 comprises a TXOP field that indicates a duration of the third TXOP. The TXOP field may be a field of a PHY header of second frame 1712. For example, the TXOP field may be a field of an HE-SIG-A field of the PHY header of second frame 1712. In an embodiment, the indication of the third TXOP in the TXOP field is obtained by converting the value of a TXVECTOR parameter TXOP_DURATION as described in section 26.11.5 of the IEEE 802.11 standard. Alternatively, or additionally, second frame 1712 may comprise a duration field that indicates the third TXOP. The duration field may be a field of a MAC header of second frame 1712.

In an embodiment, as shown in FIG. 17, the third TXOP may have a same end time as the second TXOP indicated in first frame 1710. As such, the third TXOP may not overlap with the TBTT of AP 1702.

In an embodiment, STA 1706 and/or AP 1704 may transmit a CF-End frame to truncate the third TXOP as described above with reference to FIG. 15.

Subsequently, at the TBTT of AP 1702, AP 1702 may transmit a beacon frame 1714 after performing a random backoff. As the third TXOP ends before the TBTT of AP 1702, AP 1704 may be available at the time of transmission of beacon frame 1714 and may thus successfully receive beacon frame 1714. Based on successfully receiving beacon frame 1714, AP 1704 may be able to perform CMA with AP 1702.

In an embodiment, to avoid having STA 1706 attempt to access the wireless medium immediately after the end of the third TXOP, STA 1706 may be configured to defer channel access using EDCA for a specific time period after the end of the third TXOP. Alternatively, or additionally, STA 1706 may be configured to use different EDCA parameters during a specific time period after the end of the third TXOP, where the different EDCA parameters are configured to reduce the possibility of STA 1706 gaining access to the wireless medium during the specific time period.

In the above, example procedures have been described in which a first AP may transmit a second frame to a STA indicating a second TXOP based on receiving from the STA a first frame indicating a first TXOP that overlaps with a TBTT of a second AP. Embodiments, however, are not limited to the second frame being transmitted based on the first TXOP overlapping with a TBTT of the second AP. Indeed, more generally, the second frame indicating the second TXOP may be transmitted based on the first TXOP indicated in the first frame overlapping with a predetermined event of the second AP. The predetermined event may be any transmission or reception event of the second AP. The predetermined event may be set in time by the second AP. The time of the predetermined event may be known to the first AP. For example, in addition to comprising a TBTT of the second AP, the predetermined event may comprise a scheduled TWT SP or r-TWT SP of the second AP.

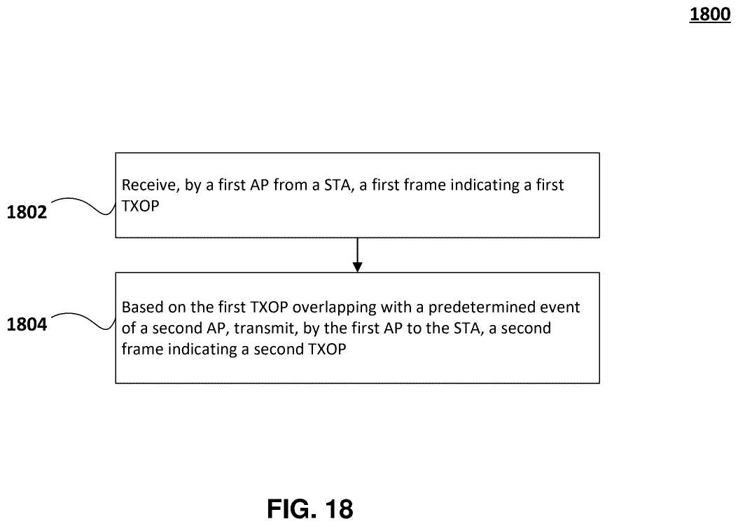

FIG. 18 illustrates an example process 1800 according to an embodiment. Example process 1800 may be performed by a first AP, such as AP 1304, AP 1404, AP 1504, AP 1604, or AP 1704. The first AP may be within communication of a second AP. The second AP may be an OBSS AP relative to the first AP. The first AP and the second AP may or may not be part of a multi-AP group. The first AP may have a STA associated with it. The first AP, the second AP, and/or the STA may support CMA. In an embodiment, supporting CMA comprises the first AP, the second AP, and/or the STA ending a TXOP before a start time of an R-TWT SP of an OBSS AP. As shown in FIG. 18, process 1800 includes steps 1802 and 1804.

Step 1802 includes receiving, by the first AP from the STA, a first frame indicating a first TXOP. In an embodiment, the first frame comprises an RTS frame or a data frame.

Step 1804 includes, based on the first TXOP overlapping with a predetermined event of a second AP, transmitting, by the first AP to the STA, a second frame indicating a second TXOP.

In an embodiment, the predetermined event comprises a TBTT of the second AP. In another embodiment, the predetermined event comprises a scheduled TWT SP or r-TWT SP of the second AP.

In an embodiment, the predetermined event is set by the second AP.

In an embodiment, the second TXOP is different from the first TXOP. In an embodiment, the second TXOP does not overlap with the predetermined event of the second AP.

In an embodiment, the second frame comprises a CTS frame, a modified CTS frame, or a BA frame. In an embodiment, the second frame comprises a field indicating presence of the second TXOP. In an embodiment, the field indicating the presence of the second TXOP comprises a duration field or a TXOP field of the second frame.

In an embodiment, transmitting the second frame comprises transmitting the second frame a time period after receiving the first frame. In an embodiment, the time period is equal to a SIFS. In another embodiment, the time period is equal to a CTS timeout interval or to the CTS timeout interval plus an xIFS. In an embodiment, the CTS timeout interval is equal to aSIFSTime+aRxPHYStartDelay+aSlotTime. In an embodiment, the xIFS is equal to a DIFS, a PIFS, a SIFS, or an AIFS.

In an embodiment, process 1800 may further comprise receiving, by the first AP from the STA, a third frame indicating a third TXOP. In an embodiment, the third frame comprises a data frame. In an embodiment, the third TXOP has a same end time as the second TXOP.

In an embodiment, process 1800 may further comprise transmitting, by the first AP to the STA, an immediate response frame in response to the third frame. In an embodiment, the immediate response frame comprises an ACK frame or a BA frame.

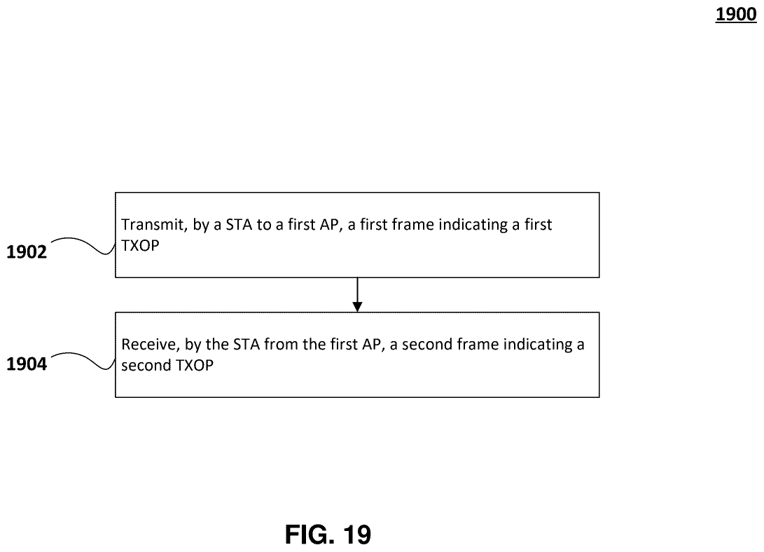

FIG. 19 illustrates another example process 1900 according to an embodiment. Example process 1800 may be performed by a STA, such as STA 1306, STA 1406, STA 1506, STA 1606, or STA 1706. The STA may be associated with a first AP. The first AP may be within communication of a second AP. The second AP may be an OBSS AP relative to the first AP. The first AP and the second AP may or may not be part of a multi-AP group. The first AP, the second AP, and/or the STA may support CMA. In an embodiment, supporting CMA comprises the first AP, the second AP, and/or the STA ending a TXOP before a start time of an R-TWT SP of an OBSS AP. As shown in FIG. 19, process 1900 includes steps 1902 and 1904.

Step 1902 includes transmitting, by the STA to the first AP, a first frame indicating a first TXOP. In an embodiment, the first frame comprises an RTS frame or a data frame.

Step 1904 includes receiving, by the STA from the first AP, a second frame indicating a second TXOP.

In an embodiment, the first TXOP overlaps with a predetermined event of the second AP. In an embodiment, the predetermined event comprises a TBTT of the second AP. In another embodiment, the predetermined event comprises a scheduled TWT SP or r-TWT SP of the second AP. In an embodiment, the predetermined event is set by the second AP.

In an embodiment, the second TXOP is different from the first TXOP. In an embodiment, the second TXOP does not overlap with the predetermined event of the second AP.

In an embodiment, the second frame comprises a CTS frame, a modified CTS frame, or a BA frame. In an embodiment, the second frame comprises a field indicating presence of the second TXOP. In an embodiment, the field indicating the presence of the second TXOP comprises a duration field or a TXOP field of the second frame.

In an embodiment, receiving the second frame comprises receiving the second frame a time period after transmitting the first frame. In an embodiment, the time period is equal to a SIFS. In another embodiment, the time period is equal to a CTS timeout interval or to the CTS timeout interval plus an xIFS. In an embodiment, the CTS timeout interval is equal to aSIFSTime+aRxPHYStartDelay+aSlotTime. In an embodiment, the xIFS is equal to a DIFS, a PIFS, a SIFS, or an AIFS.

In an embodiment, process 1900 may further comprise transmitting, by the STA to the first AP, a third frame indicating a third TXOP. In an embodiment, the third frame comprises a data frame. In an embodiment, the third TXOP has a same end time as the second TXOP.

In an embodiment, process 1900 may further comprise receiving, by the STA from the first AP, an immediate response frame in response to the third frame. In an embodiment, the immediate response frame comprises an ACK frame or a BA frame.

In the above, example procedures have been described in which a first AP may transmit a second frame to a STA indicating a second TXOP based on receiving from the STA a first frame indicating a first TXOP that overlaps with a predetermined event of a second AP. Embodiments, however, are not limited to the first and second frames indicating respective TXOPs. Indeed, more generally, the first frame may indicate a first time period and the second frame may indicate a second time period. The second frame may be transmitted based on the first time period overlapping with the predetermined event of the second AP.

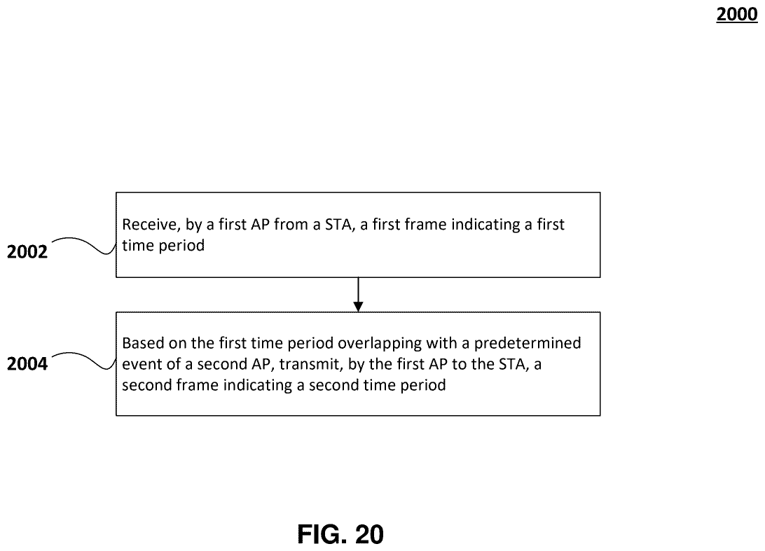

FIG. 20 illustrates an example process 2000 according to an embodiment. Example process 2000 may be performed by an AP, such as AP 1304, AP 1404, AP 1504, AP 1604, or AP 1704. The first AP may be within communication of a second AP. The second AP may be an OBSS AP relative to the first AP. The first AP and the second AP may or may not be part of a multi-AP group. The first AP may have a STA associated with it. The first AP, the second AP, and/or the STA may support CMA. In an embodiment, supporting CMA comprises the first AP, the second AP, and/or the STA ending a TXOP before a start time of an R-TWT SP of an OBSS AP. As shown in FIG. 20, process 2000 includes steps 2002 and 2004.

Step 2002 includes receiving, by the first AP from the STA, a first frame indicating a first time period. In an embodiment, the first frame comprises an RTS frame or a data frame.

In an embodiment, the first time period comprises a TXOP. In another embodiment, the first time period comprises duration information indicated by the first frame or NAV information.

Step 2004 includes, based on the first time period overlapping with a predetermined event of the second AP, transmitting, by the first AP to the STA, a second frame indicating a second time period.

In an embodiment, the predetermined event comprises a TBTT of the second AP. In another embodiment, the predetermined event comprises a scheduled TWT SP or r-TWT SP of the second AP.

In an embodiment, the predetermined event is set by the second AP.

In an embodiment, the second time period is different from the first time period. In an embodiment, the second time period does not overlap with the predetermined event of the second AP.

In an embodiment, the second frame comprises a CTS frame, a modified CTS frame, or a BA frame. In an embodiment, the second frame comprises a field indicating presence of the second time period. In an embodiment, the field indicating the presence of the second time period comprises a duration field or a time period field of the second frame.

In an embodiment, transmitting the second frame comprises transmitting the second frame a time period after receiving the first frame. In an embodiment, the time period is equal to a SIFS. In another embodiment, the time period is equal to a CTS timeout interval or to the CTS timeout interval plus an xIFS. In an embodiment, the CTS timeout interval is equal to aSIFSTime+aRxPHYStartDelay+aSlotTime. In an embodiment, the xIFS is equal to a DIFS, a PIFS, a SIFS, or an AIFS.

In an embodiment, process 2000 may further comprise receiving, by the first AP from the STA, a third frame indicating a third time period. In an embodiment, the third frame comprises a data frame. In an embodiment, the third time period has a same end time as the second time period.

In an embodiment, process 2000 may further comprise transmitting, by the first AP to the STA, an immediate response frame in response to the third frame. In an embodiment, the immediate response frame comprises an ACK frame or a BA frame.

What is claimed is:

1. A method comprising:
receiving, by a station (STA), a first beacon frame transmitted by a first access point (AP) and announcing a restricted target wake time (R-TWT) service period (SP) of a second AP;
transmitting, by the STA to the first AP after receiving the first beacon frame, a second frame initiating a first transmit opportunity (TXOP); and
based on the STA supporting R-TWT operation and being a member of a same basic service set (BSS) as the first AP, ending, by the STA, the first TXOP before a start time of the R-TWT SP of the second AP.

2. The method of claim 1, wherein the first beacon frame comprises a TWT element.

3. The method of claim 2, wherein the TWT element comprises all of: (i) a TWT wake interval exponent field, (ii) a TWT wake interval Mantissa field, (iii) a target wake time field, and (iv) a nominal minimal TWT wake duration field.

4. The method of claim 3, wherein the first AP is a member of a first BSS and the second AP is a member of a second BSS different from the first BSS.

5. The method of claim 4, wherein the transmission by the first AP of the first beacon frame is based on the first AP receiving, from the second AP, a second beacon frame announcing the r-TWT SP of the second AP.

6. The method of claim 5, further comprising transmitting, by the STA to the first AP, a third frame indicating that the STA supports R-TWT operation.

7. The method of claim 6, further comprising receiving, by the STA from the first AP, a fourth frame acknowledging the third frame.

8. A station (STA) comprising:
one or more processors; and
memory storing instructions that, when executed by the one or more processors, cause the STA to:
receive a first beacon frame transmitted by a first access point (AP) and announcing a restricted target wake time (R-TWT) service period (SP) of a second AP;
transmit, to the first AP after receiving the first beacon frame, a second frame initiating a first transmit opportunity (TXOP); and
based on the STA supporting R-TWT operation and being a member of a same basic service set (BSS) as the first AP, end, by the STA, the first TXOP before a start time of the R-TWT SP of the second AP.

9. The STA of claim 8, wherein the first beacon frame comprises a TWT element.

10. The STA of claim 9, wherein the TWT element comprises all of: (i) a TWT wake interval exponent field, (ii) a TWT wake interval Mantissa field, (iii) a target wake time field, and (iv) a nominal minimal TWT wake duration field.

11. The STA of claim 10, wherein the first AP is a member of a first BSS and the second AP is a member of a second BSS different from the first BSS.

12. The STA of claim 11, wherein the transmission by the first AP of the first beacon frame is based on the first AP receiving, from the second AP, a second beacon frame announcing the r-TWT SP of the second AP.

13. The STA of claim 12, wherein the instructions further cause the STA to transmit, to the first AP, a third frame indicating that the STA supports R-TWT operation.

14. The STA of claim 13, wherein the instructions further cause the STA to receive, from the first AP, a fourth frame acknowledging the third frame.

15. A non-transitory computer-readable medium comprising instructions that, when executed by one or more processors of a station (STA), cause the STA to:
receive a first beacon frame transmitted by a first access point (AP) and announcing a restricted target wake time (R-TWT) service period (SP) of a second AP;
transmit, to the first AP after receiving the first beacon frame, a second frame initiating a first transmit opportunity (TXOP); and
based on the STA supporting R-TWT operation and being a member of a same basic service set (BSS) as the first AP, end, by the STA, the first TXOP before a start time of the R-TWT SP of the second AP.

16. The non-transitory computer-readable medium of claim 15, wherein the first beacon frame comprises a TWT element.

17. The non-transitory computer-readable medium of claim 16, wherein the TWT element comprises all of: (i) a TWT wake interval exponent field, (ii) a TWT wake interval Mantissa field, (iii) a target wake time field, and (iv) a nominal minimal TWT wake duration field.

18. The non-transitory computer-readable medium of claim 17, wherein the first AP is a member of a first BSS and the second AP is a member of a second BSS different from the first BSS.

19. The non-transitory computer-readable medium of claim 18, wherein the transmission by the first AP of the first beacon frame is based on the first AP receiving, from the second AP, a second beacon frame announcing the r-TWT SP of the second AP.

20. The non-transitory computer-readable medium of claim 18, wherein the instructions further cause the STA to transmit, to the first AP, a third frame indicating that the STA supports R-TWT operation.
